(19) United States
(12) Patent Application Publication
(10) Pub. No.: US 2026/0273803 A1
(43) Pub. Date: Sep. 17, 2026

(54) PROCESS FOR TREATING WASTE MATERIALS HAVING A LOW SOFTENING TEMPERATURE WITH KINETIC PULVERIZATION

(71) Applicant: TORXX KINETIC PULVERIZER LIMITED, Hamilton (BM)

(72) Inventors: Christopher MUELLER, Providenciales (TC); Clint ALDRIDGE, Fayette, AL (US); Peter EVERSON, Hamilton (BM)

(73) Assignee: TORXX KINETIC PULVERIZER LIMITED, Hamilton (BM)

(21) Appl. No.: 19/671,642

(22) Filed: May 8, 2026

Related U.S. Application Data
(63) Continuation of application No. PCT/CA2024/051714, filed on Dec. 20, 2024.

(30) Foreign Application Priority Data
Dec. 22, 2023 (CA) 3224560
Dec. 22, 2023 (CA) 3224569

(51) Int. Cl. B29B 17/02; B02C 13/14; B29L 31/08

(52) U.S. Cl. CPC B29B 17/02; B02C 13/14; B02C 2013/145; B29B 2017/0231; B29L 2031/085

(57) ABSTRACT

The present disclosure relates to the treatment of waste streams having a portion of material with a low softening temperature, such as thermoplastics. Waste streams can include manufacturing waste, such as composite flooring reject material, or consumer waste. The process can include a kinetic pulverization stage with a kinetic pulverizer that produces an airflow having multiple overlapping vortices that simultaneously size-reduces the manufacturing waste and reduces or maintains an internal temperature of the kinetic pulverizer when compared with conventional size-reduction machinery so as to efficiently size reduce the thermoplastic. The kinetic pulverizer can be selectively operated at specific speeds that serve to size reduce a majority (for example, between 70% and 100%) of the waste in a single pass (one pass kinetic pulverization) or selectively liberate a portion of the manufacturing waste product. Optionally, the process can include a separation stage, such as mechanical and/or magnetic screening.

### CROSS-REFERENCE TO RELATED APPLICATIONS

This application is a continuation of International Patent Application No. PCT/CA2024/051714, entitled “PROCESS FOR TREATING WASTE MATERIALS HAVING A LOW SOFTENING TEMPERATURE WITH KINETIC PULVERIZATION,” filed Dec. 20, 2024, which claims priority to and benefit of Canadian Patent Application No. CA3224560, entitled “PROCESS FOR TREATING WASTE MATERIALS HAVING A LOW SOFTENING TEMPERATURE WITH KINETIC PULVERIZATION,” filed Dec. 22, 2023 and Canadian Patent Application No. CA3224569, entitled “PROCESS OF TREATING A FIBER-REINFORCED MATERIAL TO RECOVER A BINDER COMPONENT AND A FIBER COMPONENT,” filed Dec. 22, 2023, the contents of which are hereby incorporated by reference in their entirety.

### TECHNICAL FIELD

The technical field generally relates to processing of waste materials for size reduction and related processing. In particular, the technical field relates to processing of waste materials having a low softening temperature, such as stone-plastic-composite (SPC) flooring rejects, and recycling the processed material, for example, in a manufacturing process.

### BACKGROUND

Waste materials having a low melting point or softening temperature are ubiquitous among industrial and consumer goods. For example, during the manufacturing process for a product, reject materials, such as improperly formed products, broken products, etc., can form a separate waste stream that must be dealt with. These reject materials from the manufacturing process are often removed from the manufacturing plant as a waste product, which decreases the profitability of the manufacturing process.

Conventional treatments of manufacturing waste include manually pre-sorting the material to remove components that may be reused in the manufacturing process or disposing of the manufacturing waste as a waste stream. Some conventional processes include size-reducing the manufacturing waste using known size-reducing machinery, such as a ball mill, impactors, crushers, grinding mills, shredders, etc. However, due to the presence of materials having a low softening temperature, these size-reducing processes often require several passes to size reduce the manufacturing waste to the desired size for reintroduction into the manufacturing process. This requires additional time and expense in handling the product, higher energy costs through increased run times, etc.

Moreover, when the waste materials having a relatively low softening or melting point, such as thermoplastics, are size reduced using conventional machinery, the internal heat generated by the size-reducing machinery can cause the material to soften or liquefy. The softened or liquified material can obstruct the components of the size-reducing machinery and prevent the machine from working properly and/or cause a significantly higher energy input to provide the same size reduction.

One example type of waste material is SPC flooring rejects generated during the manufacture of SPC flooring or post-consumer SPC flooring waste. Due to their structural and chemical characteristics, SPC flooring waste is difficult to handle and process for recuperation of components for reuse in the manufacture of additional SPC flooring or other components.

Another type of waste material is asphalt shingles, including post-consumer (tear-off) waste and manufacturing (post-production) waste. Grinding and/or hammering techniques can be used to size reduce the shingles, including the asphalt component. However, the bituminous asphalt in the shingles often re-fuse together due to the heat from the machines. Furthermore, many types of asphalt shingles include a chemical sealant that is activated by solar warmth to seal the shingles on the roofing surface. However, when the asphalt shingles are subjected to convention size-reduction equipment, the resultant heat product of the machines activates the chemical sealant, causing the chemical sealant to become sticky, which increases the energy required to size reduce the shingles. When warmed, the chemical sealant can also assist with the re-fusing of the asphalt particles together, causing agglutination.

To account for the agglutination cause by the generation of heat and/or the chemical sealant, conventional methods of processing or recycling asphalt shingles include adding water and/or sand to the shredding and grinding machines. However, the water becomes contaminated with the bituminous asphalt, thus increasing the water requirement for processing the shingles. Moreover, to recover an asphalt product for use in subsequent shingles manufacturing requires the sand and/or the water to be removed from the size-reduced material in an additional step.

Accordingly, there are various challenges associated with the current treatments of waste having a low softening temperature, such as SPC flooring waste or asphalt shingles.

Moreover, fiber-reinforced materials, such as fiber-reinforced composites (FRC) are high-performance fiber composites that include a cross-link of fiber molecules within a binder constituent. The cross-linking makes the FRC material stronger than a combined strength of the individual fiber or binder components. The improved strength of FRC makes it a material that is used ubiquitously in a variety of different applications. However, the strength of FRC makes recycling FRC products at the end of their lifespan very difficult.

Some conventional methods of dealing with FRC products at the end of their lifespan include grinding or size reducing the FRC product to various sizes for use of the pulverized binder and fiber output as a filler. For example, the size-reduced FRC products can be added as a fill in concrete mixtures. However, such processes do not recycle the constituent parts of the FRC for reuse, and instead merely size reduced the product to create a filler or other inexpensive product.

Some conventional methods use strong acids, such as sulfuric acid to dissolve the binder constituent. However, this creates addition waste as the spend sulfuric acid must be dealt with. Furthermore, these methods usually require a heat component, require additional energy to process the material.

Accordingly, there are also various challenges associated with the current treatments of fiber-reinforced materials.

### SUMMARY

According to a broad aspect, there is provided a process for treating waste, the process comprising: providing a waste stream; subjecting the waste stream to a kinetic pulverization stage wherein the waste stream is fed into a kinetic pulverizer and subjected to self-collisions created by vortices within the kinetic pulverizer to produce a pulverized material comprising a size-reduced fraction; withdrawing the pulverized material from the kinetic pulverizer; and supplying the size-reduced fraction to a manufacturing process.

In some embodiments, the waste stream comprises at least a portion of material having a melting point or softening temperature of 130° C. or less, 100° C. or less, 90° C. or less, or 80° C. or less. In some embodiments, the portion of material is at least 10%, at least 20%, or at least 50%.

In some embodiments, the waste is manufacturing waste from a first manufacturing process.

In some embodiments, supplying the size-reduced fraction to the manufacturing process is supplying the size-reduced fraction to the first manufacturing process or supplying the size-reduced fraction to a second manufacturing process.

In some embodiments, the process further comprises subjecting the pulverized material to a separation stage to produce a size-reduced stream and an oversized stream.

In some embodiments, the size-reduced stream is provided to the manufacturing process.

In some embodiments, the oversized stream is subjected to a secondary kinetic pulverization stage.

In some embodiments, the kinetic pulverizer is operated at a rotation speed of less than 925 RPM.

In some embodiments, the rotation speed is between 800 RPM and 900 RPM.

In some embodiments, the separation stage comprises screening.

In some embodiments, the screening comprises using a single screen or two or more screens arranged in parallel or in series.

In some embodiments, the screening is performed using at least one of: a trommel screen, a vibrating screen, a tumbler screen, a gyratory screen, and a high frequency screen.

In some embodiments, the kinetic pulverizer is operated at a rotation speed of greater than 925 RPM.

In some embodiments, the kinetic pulverization stage is a one-pass kinetic pulverization stage.

In some embodiments, at least 80% of the waste stream is size-reduced to 1600 μm or smaller.

In some embodiments, an entirety of the waste stream is size-reduced to 1600 μm or smaller.

In some embodiments, at least 60% of the waste stream is size-reduced to 500 μm or smaller.

In some embodiments, at least 80% of the waste stream is size-reduced to 500 μm or smaller.

In some embodiments, the at least a portion of material is at least about 10% thermoplastic.

In some embodiments, the process further comprises: monitoring at least one parameter of: the waste stream, the pulverized material, the oversized stream and/or the size-reduced stream; and adjusting the kinetic pulverization stage based on the at least one parameter.

In some embodiments, the at least one parameter comprises at least one of: an infeed rate of the waste stream, size properties of the size-reduced fraction in the pulverized material, a composition of the pulverized material, and a composition of the size-reduced stream.

In some embodiments, the adjusting of the kinetic pulverization stage comprises adjusting the rotation speed and/or adjusting the infeed rate of the waste stream.

In some embodiments, the waste stream comprises reject materials from a flooring manufacturing process.

In some embodiments, the flooring manufacturing process is a resilient floor manufacturing process.

In some embodiments, the resilient floor manufacturing process comprises manufacturing a luxury vinyl tile flooring (LVT) or manufacturing a stone polymer composite (SPC).

In some embodiments, the resilient floor manufacturing process comprises manufacturing a product having at least two layers comprising different materials.

In some embodiments, the at least two layers comprise a wear layer, a core layer, a bottom layer, a decorative layer, and/or a protective layer.

In some embodiments, the different materials are selected from the group consisting of: polyvinyl chloride (PVC), limestone, aggregates, cement, sand, crushed rock, rubber, asphalt, solidified linseed oil, pine resin, cork, sawdust, and mineral fillers.

In some embodiments, the manufacturing waste stream comprise reject materials from a plastic extrusion manufacturing process.

In some embodiments, the process further comprises subjecting the manufacturing waste stream to an upstream magnetic separation stage to remove metal therefrom and produce a metal depleted feed stream that is fed to the kinetic pulverization stage.

In some embodiments, the upstream magnetic separation stage is performed by one or more magnetic separators configured relative to a feed of the waste stream.

In some embodiments, the process further comprises subjecting the pulverized output stream to a downstream magnetic separation stage to remove metal therefrom.

In some embodiments, the downstream magnetic separation stage is performed by one or more magnetic separators configured relative to a feed of the pulverized output stream.

In some embodiments, the upstream magnetic separation stage or the downstream magnetic separation stage is performed by at least one of: a non-ferrous metal separator and a ferrous metal separator.

In some embodiments, the process further comprises subjecting the pulverized material to a dust collection stage to recover a dust fraction therefrom and produce a dust reduced pulverized stream and a dust stream.

In some embodiments, at least a portion of the dust fraction is combined with at least a portion of the size-reduced stream.

In some embodiments, all of the dust fraction is combined with the size-reduced stream.

In some embodiments, the kinetic pulverizer is configured to generate an airflow that reduces an internal temperature in a housing of the kinetic pulverizer.

In some embodiments, the kinetic pulverizer is operated such that the internal temperature does not exceed 105° C.

In some embodiments, the kinetic pulverizer is operated such that the internal temperature does not exceed 93° C.

According to another aspect, there is provided a waste processing system, comprising: a kinetic pulverizer configured to receive and process a waste stream to produce a pulverized stream, wherein the kinetic pulverizer is configured to generate an airflow that reduces an internal temperature in a housing of the kinetic pulverizer; and an infeed conveyor configured to transport the waste stream to the kinetic pulverizer; wherein the waste stream has at least a portion of material having a melting point or softening temperature of 130° C. or less.

In some embodiments, the waste processing system further comprises an outlet conveyor configured to transport the pulverized stream from an outlet of the kinetic pulverizer to a manufacturing process.

In some embodiments, the waste processing system further comprises at least one separator operatively coupled to an outlet of the kinetic pulverizer and configured to receive the pulverized stream and produce a size-reduced stream and an oversized stream.

In some embodiments, the at least one separator comprises a screen.

In some embodiments, the at least one separator comprises at least one of a trommel screen, a vibrating screen, a tumbler screen, a gyratory screen, and a high frequency screen.

In some embodiments, the separator comprises a single screen or two or more screens arranged in parallel or in series.

In some embodiments, the waste processing system further comprises: a monitoring unit configured for monitoring at least one feed parameter of the manufacturing waste stream and/or at least one output parameter of the pulverized stream; and a control unit coupled to the monitoring unit and configured for adjusting the kinetic pulverizer based on the at least one feed parameter and/or the at least one output parameter.

In some embodiments, the monitoring unit and the control unit are configured such that the at least one feed parameter comprises a feed rate of the waste stream and/or a composition of the waste stream.

In some embodiments, the monitoring unit and the control unit are configured such that the at least one output parameter comprises size properties of the pulverized stream, a composition of the pulverized stream, a flow rate of the pulverized stream, a flow rate of the pulverized stream, and/or a composition of the pulverized stream.

In some embodiments, the control unit is configured to adjust the rotation speed of the kinetic pulverizer.

In some embodiments, the control unit is configured to adjust an infeed rate of the waste stream into the kinetic pulverizer.

In some embodiments, the waste processing system further comprises an upstream magnetic separator to remove metal from the waste stream and produce a metal depleted feed stream that is fed to the kinetic pulverizer.

In some embodiments, the upstream magnetic separator is operated relative to a feed of the waste stream.

In some embodiments, the waste processing system further comprises a downstream magnetic separator to remove metal from the pulverized stream.

In some embodiments, the downstream magnetic separator is operated relative to a feed of the pulverized stream.

In some embodiments, the waste processing system further comprises a dust collection unit configured to recover a dust fraction from the pulverized stream and produce a dust reduced pulverized stream.

In some embodiments, the dust collection unit is configured to supply at least a portion of the dust fraction to at least a portion of the pulverized stream.

In some embodiments, the dust collection unit comprises: a dust collector coupled with respect to an outlet of the kinetic pulverizer or with respect to the pulverizer conveyor; and a dust recovery unit coupled to the dust collector and configured to cause separation of the dust and transport of the dust fraction from the dust collector to a storage vessel.

In some embodiments, the at least a portion of material is at least a portion of thermoplastic.

In some embodiments, the at least a portion of thermoplastic is at least 10% thermoplastic.

In some embodiments, the kinetic pulverizer is operated such that the internal temperature does not exceed 105° C.

In some embodiments, the kinetic pulverizer is operated such that the internal temperature does not exceed 93° C.

According to another aspect, there is provided a process for recycling manufacturing waste comprising: providing a feedstock comprising a manufacturing reject from a manufacturing process, the manufacturing rejects comprising at least a portion of material having a melting point or softening temperature of 130° C. or less; subjecting the feedstock to a kinetic pulverization stage wherein the feedstock is fed into a kinetic pulverizer and subjected to self-collisions created by vortices within the kinetic pulverizer to produce a pulverized material; withdrawing the pulverized material from the kinetic pulverizer; and supplying the pulverized material to the manufacturing process.

In some embodiments, the process further comprises conducting the manufacturing process to produce an unsorted products stream and subjecting the unsorted products stream to an upstream separation stage to produce a sorted product stream and a waste stream comprising the manufacturing rejects.

In some embodiments, the upstream separation stage comprises manually removing the manufacturing rejects from the unsorted products stream.

According to another aspect, there is provided a process for treating asphalt shingles comprising: providing the asphalt shingles which comprise a frangible asphalt component coupled to a ductile component; subjecting the asphalt shingles to a kinetic pulverization stage wherein the asphalt shingles are fed into a kinetic pulverizer and subjected to self-collisions created by vortices within the kinetic pulverizer to produce a pulverized material comprising a size-reduced fraction derived from the frangible asphalt component and an oversized fraction derived from the ductile component;

withdrawing the pulverized material from the kinetic pulverizer; and subjecting the pulverized material to a separation stage to produce a size-reduced stream comprising asphalt and an oversized stream comprising paper or fiberglass.

In some embodiments, the ductile component comprises paper or fiberglass.

In some embodiments, the asphalt shingles further comprise an infrangible material embedded in the frangible asphalt component and/or the ductile component.

In some embodiments, the asphalt shingles further comprise a chemical sealant.

In some embodiments, the process further comprises supplying the size-reduced stream to a shingles manufacturing process.

In some embodiments, the process further comprises subjecting the size-reduced stream to one or more subsequent separation stages to produce a purified asphalt granule stream and a powdered asphalt stream.

In some embodiments, the process further comprises supplying the asphalt granule stream to a shingles manufacturing process.

According to one aspect, there is provided a process for treating fiber-reinforced materials comprising: providing a fiber-reinforced material stream comprising a fiber component embedded in a binder component; providing a kinetic pulverizer with rotating arms that create overlapping vortices that generate an airflow within the kinetic pulverizer; subjecting the fiber-reinforced material to a kinetic pulverization stage with the kinetic pulverizer to produce a pulverized material comprising the fiber component and the binder component; withdrawing the pulverized material from the kinetic pulverizer; and subjecting the pulverized material to a separation stage to isolate the fiber component from the binder component and produce an isolated fiber stream and an isolated binder stream, respectively.

In some embodiments, the process further comprises subjecting the fiber-reinforced material stream to a size-reduction pre-treatment stage to produce a size-reduced feedstock and subjecting the size-reduced feedstock to the kinetic pulverization stage.

In some embodiments, the separation stage comprises screening.

In some embodiments, the screening comprises using a single screen or two or more screens arranged in parallel or in series.

In some embodiments, the screening is performed using at least one of: a trommel screen, a vibrating screen, a tumbler screen, a gyratory screen, and a high frequency screen.

In some embodiments, the separation stage comprises a density-based separation stage.

In some embodiments, the separation stage comprises a magnetic separation stage.

In some embodiments, the process further comprises monitoring at least one parameter of: the fiber-reinforced material stream and the pulverized material; and adjusting the kinetic pulverization stage based on the at least one parameter.

In some embodiments, the at least one parameter comprises at least one of: an infeed rate of the fiber-reinforced material stream, a moisture content of the fiber-reinforced material stream, size properties of the fiber-reinforced material stream, and a composition of the fiber-reinforced material stream.

In some embodiments, the at least one parameter comprises at least one of: size properties of the pulverized material, a composition of the pulverized material, and a flow rate of the pulverized material.

In some embodiments, the adjusting of the kinetic pulverization stage comprises adjusting the rotation speed and/or adjusting the infeed rate of the fiber-reinforced material stream.

In some embodiments, the fiber-reinforced material stream is derived from post-consumer waste.

In some embodiments, the fiber-reinforced material stream comprises at least one building material comprising a fiber-reinforced composite material.

In some embodiments, the fiber-reinforced material stream comprises at least a portion of fiber-reinforced concrete.

In some embodiments, the binder component comprises a concrete matrix.

In some embodiments, the fiber component comprises at least one of: carbon fibers, organic fibers, metal fibers, polypropylene fibers, nylon fibers, and glass fibers.

In some embodiments, the fiber-reinforced material stream comprises at least a portion of fiber-reinforced composite.

In some embodiments, the fiber-reinforced composite comprises a polymer matrix composite.

In some embodiments, the binder component of the polymer matrix composite comprises at least one of: a thermoset, a thermoplastic, and an elastomeric resin.

In some embodiments, the fiber component of the polymer matrix composite comprises at least one of carbon fibers, organic fibers, metal fibers, polypropylene fibers, nylon fibers, and glass fibers.

In some embodiments, the fiber-reinforced material stream comprises wind turbine blades.

In some embodiments, the fiber-reinforced material stream comprises at least a portion of textiles.

In some embodiments, the at least a portion of textiles comprise carpet and/or rugs.

In some embodiments, the binder component comprises at least one of: an acrylic resin, a urethane resin, a thermoplastic, latex, and an epoxy resin.

In some embodiments, the fiber component comprises at least one of: synthetic fibers and organic fibers.

In some embodiments, the synthetic fibers comprise at least one of: nylon, polyester, polypropylene, polyester, and polytrimethylene terephthalate.

In some embodiments, the organic fibers comprise at least one of: sisal, cotton, hemp, and wool.

In some embodiments, the fiber-reinforced material stream further comprises an infrangible component.

In some embodiments, the process further comprises subjecting the fiber-reinforced material stream to an upstream magnetic separation stage to remove metal therefrom and produce a metal depleted feed stream that is fed to the kinetic pulverization stage.

In some embodiments, the upstream magnetic separation stage is performed by one or more magnetic separators configured relative to a feed of the fiber-reinforced material stream.

In some embodiments, the process further comprises subjecting at least one of: the pulverized material, the isolated fiber stream, and the isolated binder stream to a downstream magnetic separation stage to remove metal therefrom.

In some embodiments, the downstream magnetic separation stage is performed by one or more magnetic separators configured relative to a feed of the at least one of: the pulverized material, the isolated fiber stream, and the isolated binder stream.

In some embodiments, the upstream magnetic separation stage or the downstream magnetic separation stage is performed by at least one of: a non-ferrous metal separator and a ferrous metal separator.

In some embodiments, the process further comprises subjecting the pulverized material to a dust collection stage to recover a dust fraction therefrom and produce a dust reduced pulverized stream that is fed to the separation stage.

In some embodiments, at least a portion of the dust fraction is combined with at least a portion of the pulverized material.

In some embodiments, all of the dust fraction is combined with the size-reduced stream.

In some embodiments, the dust collection stage comprises: a dust collector coupled with respect to an outlet of the kinetic pulverization stage or with respect to a solids transport device configured for transporting the pulverized material away from the kinetic pulverization stage; and a dust recovery unit coupled to the dust collector and configured to cause separation of the dust fraction and transport of the dust fraction from the dust collector to a storage vessel.

In some embodiments, the dust collector comprises a settling chamber.

In some embodiments, the dust recovery unit comprises a baghouse that is in fluid communication via ducting with the settling chamber.

In some embodiments, the dust recovery unit comprises a cyclone that is in fluid communication via ducting with the settling chamber.

In some embodiments, the solids transport device comprises a conveyor.

In some embodiments, the dust collector surrounds the solids transport device along a majority of a length thereof.

According to another aspect, there is provided a fiber-reinforced material processing system, comprising: a kinetic pulverizer configured to receive and process a fiber-reinforced material stream to produce a pulverized stream; a pulverizer conveyor configured to transport the pulverized stream downstream; and at least one separator operatively coupled to the pulverizer conveyor and configured to receive the pulverized stream and produce a size-reduced stream and an oversized stream. In some embodiments, the separator comprises a screen.

In some embodiments, the separator comprises at least one of a trommel screen, a vibrating screen, a tumbler screen, a gyratory screen, and a high frequency screen.

In some embodiments, the separator comprises a single screen or two or more screens arranged in parallel or in series.

In some embodiments, the system further comprises: a monitoring unit configured for monitoring at least one feed parameter of the fiber-reinforced material stream and/or at least one output parameter of the pulverized stream, the oversized stream, and/or the size-reduced stream; and a control unit coupled to the monitoring unit and configured for adjusting the kinetic pulverizer based on the at least one feed parameter and/or the at least one output parameter.

In some embodiments, the monitoring unit and the control unit are configured such that the at least one feed parameter comprises a feed rate of the fiber-reinforced material stream and/or a composition of the fiber-reinforced material stream.

In some embodiments, the monitoring unit and the control unit are configured such that the at least one output parameter comprises size properties of the pulverized stream, a composition of the pulverized stream, a flow rate of the pulverized stream, a flow rate of the oversized stream, a flow rate of the size-reduced stream, a composition of the oversized stream, and/or a composition of the size-reduced stream.

In some embodiments, the control unit is configured to adjust the rotation speed of the kinetic pulverizer.

In some embodiments, the control unit is configured to adjust an infeed rate of the fiber-reinforced material stream into the kinetic pulverizer.

In some embodiments, the system further comprises an upstream magnetic separator to remove metal from the fiber-reinforced material stream and produce a metal depleted feed stream that is fed to the kinetic pulverizer.

In some embodiments, the upstream magnetic separator is operated relative to a feed of the fiber-reinforced material stream.

In some embodiments, the system further comprises a downstream magnetic separator to remove metal from at least one of: the pulverized output stream, the oversized stream, and the size-reduced stream.

In some embodiments, the downstream magnetic separator is operated relative to a feed of the at least one of: the pulverized output stream, the oversized stream, and the size-reduced stream.

In some embodiments, the at least one separator is the downstream magnetic separator.

In some embodiments, the system further comprises a dust collection unit configured to recover a dust fraction from the pulverized stream and produce a dust reduced pulverized stream that is fed to the screen.

In some embodiments, the dust collection unit is configured to supply at least a portion of the dust fraction to be combined with at least a portion of the size-reduced stream.

In some embodiments, the dust collection unit comprises: a dust collector coupled with respect to an outlet of the kinetic pulverizer or with respect to the pulverizer conveyor; and a dust recovery unit coupled to the dust collector and configured to cause separation of the dust and transport of the dust fraction from the dust collector to a storage vessel.

In some embodiments, the dust collector comprises a settling chamber.

In some embodiments, the dust recovery unit comprises a baghouse that is in fluid communication via ducting with the settling chamber.

In some embodiments, the dust recovery unit comprises a cyclone that is in fluid communication via ducting with the settling chamber.

In some embodiments, the dust collector surrounds the kinetic pulverizer along a majority of a length thereof.

According to another aspect, there is provided a process for treating fiber-reinforced materials comprising: providing a feedstock comprising a fiber component embedded in a binder component; subjecting the feedstock to a kinetic pulverization stage wherein the feedstock is fed into a kinetic pulverizer and subjected to self-collisions created by vortices within the kinetic pulverizer to produce a pulverized material comprising a size-reduced fraction derived from the binder component and an oversized fraction derived from the fiber component; withdrawing the pulverized material from the kinetic pulverizer; and subjecting the pulverized material to a separation stage to produce a binder stream and a fiber stream.

In some embodiments, the process further comprises subjecting a fiber-reinforced source material to an upstream separation stage to produce at least one stream of the feedstock.

In some embodiments, the upstream separation stage comprises mechanical screening to pre-size the fiber-reinforced source material to produce an oversized stream and an undersized stream of the feedstock.

In some embodiments, the process further comprises subjecting the oversized stream to a size-reduction pre-treatment stage to produce a size-reduced feedstock and subjecting the size-reduced feedstock to the kinetic pulverization stage.

In some embodiments, the process further comprises subjecting the feedstock to a size-reduction pre-treatment stage to produce a size-reduced feedstock.

In some embodiments, the process further comprises subjecting the size-reduced feedstock to a size-based pre-treatment separation stage to produce an oversized stream and an undersized stream of the feedstock.

In some embodiments, the process further comprises subjecting the oversized stream to a secondary size-reduction pre-treatment stage to produce a secondary size-reduced feedstock and subjecting the size-reduced feedstock to the size-based pre-treatment separation stage to produce the oversized stream and the undersized stream of the feedstock.

In some embodiments, the process further comprises subjecting the undersized stream of the feedstock to the kinetic pulverization stage.

According to another aspect, there is provided a process for treating wind turbine blades comprising: providing the wind turbine blades which comprise a fiber component embedded in a binder component; subjecting the wind turbine blades to a kinetic pulverization stage to produce a pulverized material, wherein the wind turbine blades are fed into a kinetic pulverizer and subjected to self-collisions created by vortices within the kinetic pulverizer to airstrip the binder component from the fiber component and produce a size-reduced fraction derived from the binder component and an oversized fraction derived from the fiber component; withdrawing the pulverized material from the kinetic pulverizer; and subjecting the pulverized material to a separation stage to produce a binder stream comprising the binder component and a fiber stream comprising the fiber component.

In some embodiments, the process further comprises subjecting the wind turbine blades to a size-reduction pre-treatment stage to produce a size-reduced feedstock.

In some embodiments, the process further comprises subjecting the size-reduced feedstock to a size-based pre-treatment separation stage to produce an oversized stream and an undersized stream.

In some embodiments, the oversized stream is redirected back to the size-reduction pre-treatment stage.

In some embodiments, the undersized stream is subjected to the kinetic pulverization stage.

In some embodiments, the process further comprises subjecting the pulverized material to one or more subsequent kinetic pulverization stages.

In some embodiments, the kinetic pulverizer is operated to optimize a resident time of the wind turbine blades in the kinetic pulverizer.

According to another aspect, three is provided a process for treating fiber-reinforced concrete comprising: providing the fiber-reinforced concrete comprising a concrete component coupled to a fiber component; subjecting the fiber-reinforced concrete to a kinetic pulverization stage wherein the fiber-reinforced concrete is fed into a kinetic pulverizer and subjected to self-collisions created by vortices within the kinetic pulverizer to airstrip the concrete component from the fiber component and produce a pulverized material comprising a size-reduced fraction derived from the concrete component and an oversized fraction derived from the fiber component; withdrawing the pulverized material from the kinetic pulverizer; and subjecting the pulverized material to a separation stage to produce a concrete stream comprising the concrete component and a fiber stream comprising the fiber component.

In some embodiments, the process further comprises subjecting the fiber-reinforced concrete to a size-reduction pre-treatment stage to produce a size-reduced feedstock.

In some embodiments, the process further comprises subjecting the size-reduced feedstock to a size-based pre-treatment separation stage to produce an oversized stream and an undersized stream.

In some embodiments, the oversized stream is redirected back to the size-reduction pre-treatment stage.

In some embodiments, the undersized stream is subjected to the kinetic pulverization stage.

In some embodiments, the process further comprises subjecting the pulverized material to one or more subsequent kinetic pulverization stages.

In some embodiments, the kinetic pulverizer is operated to optimize a resident time of the fiber-reinforced concrete in the kinetic pulverizer.

According to another aspect, there is provided a process for treating a carpet product comprising: providing the carpet product comprising a binder backing component coupled to a fiber component; subjecting the carpet product to a kinetic pulverization stage wherein the carpet product is fed into a kinetic pulverizer and subjected to self-collisions created by vortices within the kinetic pulverizer to airstrip the binder backing component from the fiber component and produce a pulverized material comprising a size-reduced fraction derived from the binder backing component and an oversized fraction derived from the fiber component; withdrawing the pulverized material from the kinetic pulverizer; and subjecting the pulverized material to a separation stage to produce a binder backing stream comprising the binder backing component and a fiber stream comprising the fiber component.

In some embodiments, the process further comprises subjecting the pulverized material to one or more subsequent kinetic pulverization stages.

In some embodiments, the kinetic pulverizer is operated to optimize a resident time of the fiber-reinforced concrete in the kinetic pulverizer.

### BRIEF DESCRIPTION OF FIGURES

FIG. 1A is a process flow diagram for treating a manufacturing waste stream using kinetic pulverization, optionally followed by a separation stage;

FIG. 1B is a process flow diagram for treating a fiber-reinforced material stream using kinetic pulverization followed by separation stages;

FIG. 1C is a process flow diagram for treating a fiber-reinforced material stream using kinetic pulverization followed by separation stages;

FIG. 2 is a left-side perspective view of a pulverizing apparatus, showing a motor and a housing for the pulverizing apparatus, according to an implementation;

FIG. 3 is a right-side perspective view of the pulverizing apparatus illustrated in FIG. 2, showing an outlet proximate the bottom end of the housing;

FIG. 4 is a bottom perspective view of the pulverizing apparatus illustrated in FIG. 2, showing a belt connection connecting the motor and a rotatable shaft;

FIG. 5 is a section view of the housing illustrated in FIG. 3, showing the rotatable shaft and rotors positioned within the housing;

FIG. 6 is a partially exploded view of the housing for the pulverizing apparatus illustrated in FIG. 2;

FIG. 7 is a top sectional view of the housing for the pulverizing apparatus illustrated in FIG. 2, showing a plurality of deflectors spaced about the rotatable shaft along the housing sidewall;

FIG. 8 is a section view of the housing shown in FIG. 5 with the rotatable shaft and rotors removed therefrom, showing shelves positioned along the sidewall at different levels within the housing;

FIG. 9 is a partially sectioned view of a pulverizing rotor mounted within the housing for the pulverizing apparatus illustrated in FIG. 2, showing the vortices created within the housing;

FIG. 10 is a schematic top view of the housing according to an implementation, showing overlapping vortices within the interior chamber of the housing;

FIG. 11 is a schematic cross-sectional view of a kinetic pulverizer according to another implementation, having an infeed conveyor and an outlet conveyor.

FIG. 12 is a process flow diagram for treating a manufacturing waste stream using kinetic pulverization followed by screening, and also including a magnetic separation stage and a dust collection stage;

FIG. 13 is a process flow diagram for treating a manufacturing waste stream using kinetic pulverization followed by screening, and also including a dust collection stage;

FIG. 14 is a side view schematic of an example magnetic separation stage;

FIG. 15 is a side view schematic of another example of a magnetic separation stage;

FIG. 16 is a photographic view of an exemplary SPC flooring reject material after being subjected to a kinetic pulverization stage and a dust collection stage, showing a dust-depleted pulverized output fraction and a dust fraction;

FIG. 17 is a photographic view of an exemplary SPC flooring reject material after being subjected to a kinetic pulverization stage and a dust collection stage, showing a dust-depleted pulverized output fraction and a dust fraction;

FIG. 18 is a photographic view of an exemplary shingles waste material after being subjected to a kinetic pulverization stage and multiple separation stages;

FIG. 19 is a photographic view of an exemplary shingles waste material after being subjected to a kinetic pulverization stage and multiple separation stages;

FIG. 20 is a photographic view of an exemplary shingles waste material after being subjected to a kinetic pulverization stage and multiple separation stages;

FIG. 21A is a photographic view of a one-time pre-shredded feedstock resulting from wind turbine blades after being subjected to a single size-reduction pre-treatment stage;

FIG. 21B is a photographic view of the one-time pre-shredded feedstock in FIG. 21A;

FIG. 21C is a photographic view of a pulverized output stream resulting from the one-time pre-shredded feedstock shown in FIG. 21A being subjected to a kinetic pulverization stage;

FIG. 21D is a photographic view of an undersized stream resulting from the pulverized output stream shown in FIG. 21C being subjected to a first separation stage;

FIG. 21E is a photographic view of an oversized stream resulting from the pulverized output stream shown in FIG. 21C being subjected to a first separation stage;

FIG. 22A is a photographic view of a twice pre-shredded feedstock resulting from the one-time pre-shredded feedstock shown in FIG. 21A being subjected to a second size-reduction pre-treatment stage;

FIG. 22B is a photographic view of the twice pre-shredded feedstock in FIG. 22A;

FIG. 22C is a photographic view of a pulverized output stream resulting from the twice pre-shredded feedstock shown in FIG. 22A being subjected to a kinetic pulverization stage;

FIG. 22D is a photographic view of an undersized stream resulting from the pulverized output stream shown in FIG. 22C being subjected to a first separation stage;

FIG. 22E is a photographic view of a second undersized stream resulting from the undersized stream shown in FIG. 22D being subjected to a second separation stage;

FIG. 22F is a photographic view of a third undersized stream resulting from the second undersized stream shown in FIG. 22E being subjected to a third separation stage;

FIG. 22G is a photographic view of a fourth undersized stream resulting from the third undersized stream shown in FIG. 22F being subjected to a fourth separation stage;

FIG. 22H is a photographic view of a dust fraction isolated from the pulverized output stream shown in FIG. 22C during a dust collection stage;

FIG. 22I is a photographic view of a screened dust fraction isolated from the dust fraction shown in FIG. 22H during a dust separation stage;

FIG. 23A is a photographic view of a pulverized output stream resulting from the pulverized output stream shown in FIG. 22A being subjected to a second kinetic pulverization stage;

FIG. 23B is a photographic view of an undersized stream resulting from the pulverized output stream shown in FIG. 23A being subjected to a first separation stage;

FIG. 23C is a photographic view of a second undersized stream resulting from the undersized stream shown in FIG. 23B being subjected to a second separation stage;

FIG. 23D is a photographic view of a third undersized stream resulting from the second undersized stream shown in FIG. 23C being subjected to a third separation stage;

FIG. 23E is a photographic view of a fourth undersized stream resulting from the third undersized stream shown in FIG. 23D being subjected to a fourth separation stage;

FIG. 24A is a photographic view of a sorted stream of fiber-reinforced concrete feedstock resulting from a manual sorting pre-treatment stage;

FIG. 24B is a photographic view of infrangible (metal) fasteners removed from the fiver-reinforced concrete feedstock during the manual sorting pre-treatment stage;

FIG. 24C is a photographic view of an undersized stream resulting from the sorted stream shown in FIG. 24A being subjected to a size-reduction pre-treatment stage;

FIG. 24D is a photographic view of the undersized stream shown in FIG. 24C;

FIGS. 25A and 25B are photographic views of a first pulverized material resulting from the undersized stream shown in FIG. 24C being subjected to a kinetic pulverization stage operated at 800 to 700 RPM;

FIGS. 26A and 26B are photographic views of a second pulverized material resulting from the undersized stream shown in FIG. 24C being subjected to a kinetic pulverization stage operated at 600 RPM;

FIG. 27A is a photographic view of an oversized stream resulting from the first pulverized material shown in FIGS. 25A and 25B being subjected to a separation stage using a 6.3 mm mechanical screen;

FIG. 27B is a photographic view of a second oversized stream resulting from the undersized stream of the separation stage being subjected to a second separation stage using a 3 mm mechanical screen;

FIG. 27C is a photographic view of a third oversized stream resulting from a second undersized stream of the second separation stage being subjected to a third separation stage using a 0.9 mm mechanical screen;

FIG. 27D is a photographic view of a third undersized stream resulting from the third separation stage;

FIG. 28A is a photographic view of an oversized stream resulting from the second pulverized material shown in FIGS. 26A and 26B being subjected to a separation stage using a 6.3 mm mechanical screen;

FIG. 28B is a photographic view of a second oversized stream resulting from the undersized stream of the separation stage being subjected to a second separation stage using a 3 mm mechanical screen;

FIG. 28C is a photographic view of a third oversized stream resulting from the second undersized stream of the second separation stage being subjected to a third separation stage using a 0.9 mm mechanical screen; and

FIG. 28D is a photographic view of a third undersized stream resulting from the third separation stage.

### DETAILED DESCRIPTION

### Materials Having a Low Softening Temperature

The treatment of waste streams derived from manufacturing waste, manufacturing source material, or post-consumer waste can include a kinetic pulverization stage through a kinetic pulverizer to generate a size reduced stream. The size reduced stream can be implemented back into the manufacturing process that the waste was received from or can be used in a subsequent manufacturing process to produce a secondary product. For example, deformed, damaged, scratched, broken products from the manufacturing process can be directed, automatically or manually, to a kinetic pulverization stage to facilitate size reduction. Alternatively, post-consumer waste that includes materials having a low softening temperature can be subjected to the kinetic pulverization stage to produce a size reduced stream. The size reduced stream can then be subjected to screening, if necessary, prior to being introduced or re-introduced into a manufacturing process.

In some implementations, the pulverization stage enables the processing of the waste having a low softening temperature in a single pass (“one pass”). The generation of counter-rotating airflow vortices within the kinetic pulverizer provides for a reduced internal temperature of the kinetic pulverizer when compared with conventional size reduction machinery. While the internal temperature of the kinetic pulverizer during operation is higher than the ambient temperature, the vortices reduce the internal temperature enough to prevent materials having a low melting or softening temperature from softening or liquifying. For some waste materials, such as those containing at least a portion of material having a melting point or softening temperature of 130° C. or less, a reduced internal temperature prevents the material from softening or liquifying, which can allow for a higher output of pulverized material, a smaller particle size, a reduced energy input to size reduce, and longer run times. The pulverized material can optionally be subjected to a separation stage, which may include mechanical screening, magnetic separation, density-based separation, etc., to separate any remaining oversized material from the size-reduced material. The separated oversized material can, optionally, be subjected to a second kinetic pulverization stage. In some implementations, the size reduced material can then be directly introduced or reintroduced into a manufacturing process.

In some implementations, the pulverization stage can be adjusted and/or optimized to enable a consistent size reduction of the waste material and/or enable the processing of the waste material in a single pass. In other implementations, the pulverization stage can be adjusted and/or optimized to enable a separation and liberation of a fraction of the waste material. Adjusting or optimizing the pulverization stage can include adjusting the speed of the rotor, thus affecting the rotational speed of the arms on the kinetic pulverizer and the airflow currents internal to the kinetic pulverizer (which in turn can affect the internal temperature of the kinetic pulverizer and thus the temperature of the materials being size reduced). Additionally, or alternatively, adjusting or optimizing the pulverization stage can include adjusting the infeed rate at the inlet of the kinetic pulverizer.

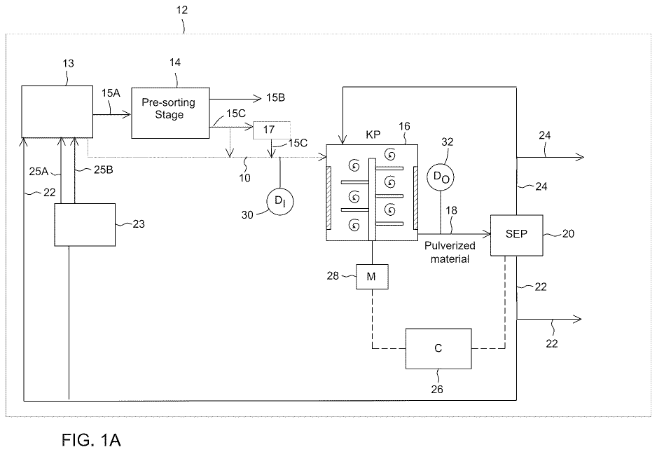

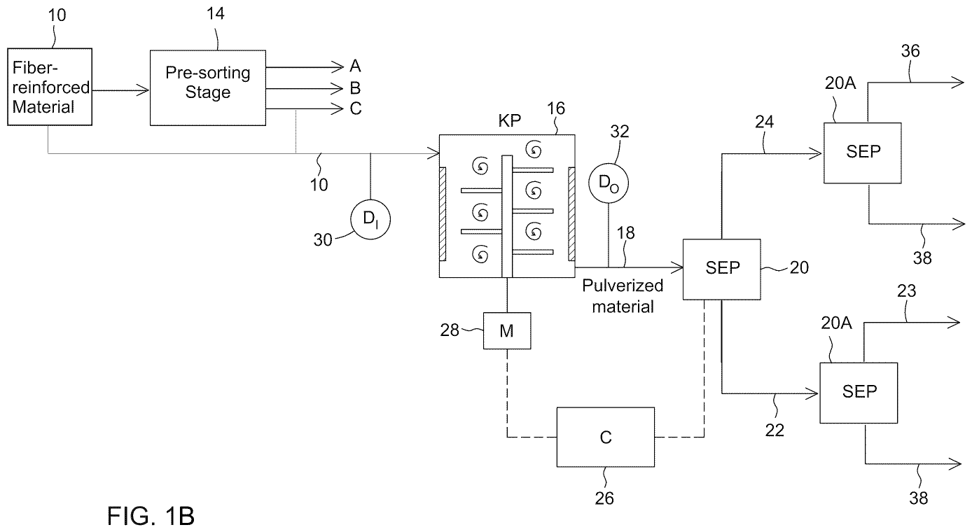

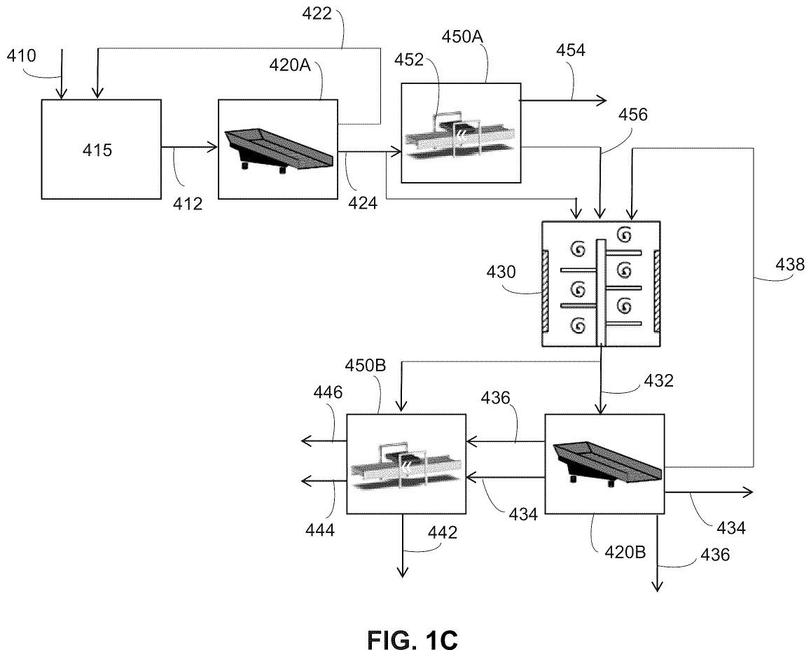

Referring to FIG. 1A, an exemplary process of treating manufacturing waste for subsequent use in a manufacturing process is shown. A feedstock 10 that is derived from and/or generated in a manufacturing plant 12 and/or obtained from a pre-sorting stage 14 is supplied to a kinetic pulverization stage 16 to produce a pulverized output stream 18. In some implementations, the manufacturing plant 12 includes a manufacturing stage 13 to produce an unsorted product stream 15A. The unsorted product stream 15A can be automatically or manually sorted in the pre-sorting stage 14 to remove any reject materials, such as deformed, incomplete, or damaged products and produce a sorted products stream 15B and a waste stream 15C. In the exemplary embodiment, the products stream 15B is the manufactured product, such as stone-plastic-composite flooring tiles. However, it is also contemplated that the products stream 15B can be the manufacture of a product that is different from the product that generated the manufacturing waste.

The feedstock 10 can be obtained from the waste stream 15C. In some implementations, the waste stream 15C is automatically or manually subjected to the kinetic pulverization stage 16 at the time of separation. For example, the unsorted products stream 15A can be subjected to a pre-sorting stage 14 that consists of automatic separation of reject materials into the sorted products stream 15B and the waste stream 15C. The waste stream 15C can be sorted onto or diverted to a conveyer belt that automatically inputs the waste stream 15C into a kinetic pulverizer as the feedstock 10 to subject the waste stream 15C to the kinetic pulverization stage 16.

In other implementations, the waste stream 15C can be diverted into a storage area 17 and then subjected to the kinetic pulverization stage 16 when pre-determined conditions are met, such as a pre-determined volume of reject materials, a pre-determined cooled temperature (for example, with injection molding waste or other manufactured products that require heat), or on a pre-determined schedule (for example, to comply with manufacturing plant 12 staff schedules). The storage area 17 can include sensors and/or timers to determine when the pre-determined condition(s) are met and to send a signal to a process to automatically subject the waste stream 15C to the kinetic pulverization stage 16 when the pre-determined condition(s) are met. In some implementations, the waste stream 15C is generated at the manufacturing plant 12 and then transported to a dedicated facility for conducting the kinetic pulverization stage 16.

In some implementations, the feedstock 10 can be generated from post-consumer waste of the manufactured product. For example, the product is produced during a manufacturing stage 13 and sold to a consumer. After the consumer has used the product for its intended purpose, it is discarded as post-consumer waste. The post-consumer waste product can be separated from a general waste stream, such as municipal or landfill waste, or a specified waste stream, such as construction and demolition debris, to produce a post-consumer waste stream as the feedstock 10. The post-consumer waste stream can then be processed with a kinetic pulverization stage 16.

Depending on the type of product being manufactured, the feedstock 10 can include frangible materials as well as infrangible materials and/or ductile materials. The frangible materials are typically hard, brittle, or friable such that the kinetic pulverization facilitates notable size reduction, converting the frangible materials into a size-reduced fraction. The frangible materials are size-reduced, for example to sand or silt sized particles, and is homogenized to produce the pulverized output stream 18. The ductile materials, on the other hand, are pliable and the kinetic pulverizer can be operated such that the ductile materials are not significantly size-reduced by the kinetic pulverization stage 16. In contrast, in the context of the present application, the infrangible material is meant to include typically tough and unbreakable material and would not be significantly size-reduced by the pulverizer, such as metal.

In some implementations, the feedstock 10 includes at least 85%, 90%, 95%, 99%, or 100% frangible materials, such that at least 85%, 90%, 95%, 99%, or 100% of the feedstock 10 is size-reduced in the pulverized output stream 18. In some implementations, the feedstock 10 includes a frangible fraction and a ductile faction and the kinetic pulverization stage is optimized to size reduce the ductile faction with the frangible fraction. For example, the kinetic pulverization stage 16 can be optimized to size reduce the frangible fraction and the ductile fraction with a single pass (one pass) and having a relatively uniform particle size. Alternatively, the kinetic pulverization stage 16 can be optimized to size reduce only the frangible fraction while allowing the ductile fraction to remain oversized, such that it can be separated based on size.

In some implementations, the pulverized output stream 18 can be subjected to a separation stage 20 to ensure that the particle size of the material is sufficiently small and recover a size-reduced stream 22 largely composed of the broken-down frangible material that can be reintegrated into the manufacturing process, and, optionally, smaller pieces of infrangible material, and an oversized material stream 24, that can be largely composed of the frangible material, larger pieces of the infrangible material that did not undergo sufficient size reduction, and/or ductile materials.

The size-reduced stream 22 can be directly reintegrated back into the manufacturing stage 13 that created the original product, into a new manufacturing stage 13, such as for the production of a new product, or can undergo a treatment stage 23, which can be, for example, a separation stage or other treatment stage to prepare the size-reduced stream 22 for reintegration back into the original manufacturing stage 13 or a new (secondary) manufacturing stage 13. In some embodiments, the treatment stage 23 is a separation stage that can include separation based on size, density, colour, shape, etc. In the exemplary embodiment, the treatment stage 23 is a separation stage to produce a first recycled stream 25A and a second recycled stream 25B. The first and second recycled streams 25A, 25B can be introduced into the manufacturing stage 13 at the same time or at different stages of manufacturing (such as for the creation of different layers of a layered product).

For example, when the manufacturing reject waste is a multi-layered flooring tile that comprises an inorganic material, such as aggregate or stone, and a polymer material, such as thermoplastic, the treatment stage 23 can include a density separation stage to separate the inorganic material as a first recycled stream 25A and the polymer material as a second recycled stream 25B. The first and second recycled streams 25A, 25B, can then be reused as the inorganic and polymer materials during the manufacturing stage 13. In some implementations, the first and/or second recycled streams 25A, 25B can be used in the same manufacturing stage 13 that the manufacturing waste was derived from or can be used in secondary manufacturing stages for the production of a different product (i.e., sold or reused as a source material for manufacturing a new item unrelated to the product the waste stream was derived from).

The oversized material stream 24 can be subjected to another separation stage 20 or redirected back to a secondary kinetic pulverization stage 16. In some embodiments, the oversized material stream 24 is automatically redirected back to the kinetic pulverizer for a kinetic pulverization stage 16.

The separation step 20 can be performed in one or more stages and can use a variety of separation equipment. For example, various types of screens can be used, such as a vibrating screen, a trommel screen, a tumbler screen, a gyratory screen, and/or a high frequency screen. Other types of separation equipment can also be used, such as dust removal and/or magnetic or metal separation. The separation equipment could be new and dedicated for the kinetic pulverization stage 16, or could be part of the existing equipment at the manufacturing plant 12. In some implementations, the pulverized output stream 18 is subjected to separation to produce more than two streams that may have various properties. For example, when the kinetic pulverization stage is optimized to separate a ductile material, the ductile material can be separated from the pulverized frangible material. In some implementations, the separation stage 20 can aid separation and enable downstream repurposing or disposal. The separation stage 20 can, for example, include multiple separators (e.g., screens, metal separation, sensor-based sorters, and dust separation) arranged in parallel or in series.

In some implementations, the separation stage 20 can include a metal separation stage to separate the infrangible fraction of ferrous and/or nonferrous metals from the pulverized output material 18 to produce a metal depleted stream.

In some implementations, the separation stage 20 can include other separation techniques, such as solvent precipitated separation, density-based separation techniques, such as hydrocyclone separators or floatation separation pools, optical separation techniques, such as laser separation or colour-based separation, etc. The separation stage 20 can be used to isolate one or more of the components used in the manufacturing process, such that the isolated component can be re-used in the manufacturing process. For example, when the feedstock is manufacturing waste that is rejection material from a resilient flooring manufacturing process or post-consumer waste derived from used resilient flooring products, the pulverized output material can include a mix of all materials used to manufacture the resilient flooring, such as PVC and limestone. The separation stage 20 can include solvent precipitated separation techniques to separate the PVC from the limestone, thus allowing a pure or enriched PVC or limestone stream to be reintroduced into the manufacturing process.

### Fiber-Reinforced Materials

Fiber-reinforced materials, such as fiber-reinforced concrete, fiber-reinforced composites (FRCs), and/or textiles having a non-fiber binder component are used in a large variety of materials and applications. For example, FRC materials can be used to produce high-strength lightweight materials, such as in the aerospace, power generation, automotive, and construction industries. FRC materials can be used to produce a number of products, including, without limitation, wind turbine blades, construction materials, such as siding, FRC planks, etc., vehicle components, epoxies, glass reinforcements (fiberglass), airplane hulls, etc. Similarly, fiber-reinforced concrete can be used in a number of applications, including construction and building materials. Fiber-reinforced materials can also include textiles that have a fiber component and a binder component, such as carpets or rugs that include fibers woven in a backing binder material, such as thermoplastics, including polypropylene and/or polyvinyl chloride (PVC), polyurethane, and/or latex.

Fiber-reinforced materials include materials containing a fiber component that is embedded or encased in a binder component. In the context of the present disclosure, “binder component” can include any non-fiber component of the fiber-reinforced material, such as the plastic in a fiber-reinforced plastic material, the cementitious or concrete matrix in fiber-reinforced concrete, and/or the backing material in a carpet or rug. Fiberglass, for example, is a fiber-reinforced material comprising glass fibers embedded in a plastic resin matrix. Separation of the fiber component from the binder component can be achieved through a kinetic pulverization stage. When the fiber-reinforced material is processed using a kinetic pulverizer, the fiber-reinforced material is size-reduced and the fiber component is air stripped from the binder component simultaneously or in sequential kinetic pulverization stages. Following the kinetic pulverization stage, the fiber component can be isolated from the binder component using separation techniques to provide two individual homogenous streams of reinforcing fiber and binder. The isolated fiber components and/or binder components can then be recycled for subsequent use in other products.

In some implementations, the pulverization stage enables the binder component to be size-reduced while the fiber component is liberated and remains as an oversized fraction in the pulverized material, which can be isolated using size-based separation techniques, such as screening. In other implementations, the binder component and the fiber component are size reduced to a similar or substantially homogenous size and then are individually isolated using separation techniques, such as solvent based separation, density-based separation, optical separation, etc. In other implementations, the fiber component can be separated using a dust collection stage and/or as an undersized stream of a separation stage. The separation techniques used in the separation stage to isolate the fiber component from the binder component can depend on the type of feedstock (i.e., the type of fiber and/or the type of binder in the fiber-reinforced material) and/or the level of separation achieved with the kinetic pulverizer.

Referring now to FIG. 1B, a feedstock 10 that includes at least a portion of fiber-reinforced material is supplied to a kinetic pulverization stage 16 to produce a pulverized output stream 18. The feedstock 10 can be obtained from a pre-sorting stage 14 where a waste or recycling stream can be sorted and the fiber-reinforced material components can be isolated as the feedstock 10, either manually or automatically using a sorting system (for example, by size, density, color, weight, etc.).

In some implementations, the pulverized output stream 18 can then be subjected to a separation stage 20 to recover a size-reduced stream 22 largely composed of the broken-down binder component, and optionally small pieces of infrangible material, such as metal, and an oversized material stream 24, that can be largely composed of the fiber component and, optionally pieces of infrangible material. The separation stage 20 can be performed in one or more stages and can use a variety of separation equipment. For example, various types of screens can be used, such as a vibrating screen, a trommel screen, a tumbler screen, a gyratory screen, and/or a high frequency screen. Other types of separation equipment can also be used, such as dust removal or magnetic or metal separation. The separation equipment could be new and dedicated for the fiber component and binder component recovery process described herein, or could be part of an existing separation stage in the facility.

In some implementations, the pulverized output stream 18 is subjected to the separation stage 20 to produce more than two streams that may have various properties that aid separation and enable downstream repurposing or disposal. The separation stage 20 can, for example, include multiple separators (e.g., screens, metal separation, sensor-based sorters, weight-based separators, density-based separators, and/or dust separation) arranged in parallel or in series.

In some implementations, as shown in FIG. 1B, the size-reduced stream 22 that includes the binder component and/or the oversized stream 24 that includes the fiber component and, in some cases, an infrangible fraction, can undergo a secondary separation stage 20A to separate the binder component, the fiber component, and, when present, the infrangible fraction into a binder stream 23, a fiber stream 36, and an infrangible stream 38, respectively. The separation step 20A can include mechanical screening to sort the oversized stream 24 by size or a metal separation stage to separate the infrangible fraction of ferrous and/or nonferrous metals from the ductile fraction of non-metallic materials to produce the infrangible stream 38 and the ductile stream 36. In other embodiments, the separation step 20A can include a metal separation stage to separate the infrangible fraction of ferrous and/or nonferrous metals from the binder fraction of non-metallic materials to produce the infrangible stream 38 and the binder stream 23, respectively.

Referring now to FIG. 1C, a fiber-reinforced material 410 that includes a binder component, a fiber component, and optionally, an infrangible component, can be transported to a processing facility. In some implementations, the fiber-reinforced material 410 undergoes a size-reduction pre-treatment stage 415 and the size-reduced feedstock 412 is subjected to a size-based pre-treatment separation stage 420A, for example, with mechanical screens, to produce an oversized stream 422 and an undersized stream 424. The size-based pre-treatment separation stage 420A can be set to a size that is acceptable for the kinetic pulverizer to accept based on the type of feedstock 410. For example, the size-based pre-treatment separation stage 420A can be configured to screen out the pieces of the size-reduced feedstock 412 that is larger than a size between about 2 inches and about 10 inches, or higher, for dense feedstocks, or between about 10 inches and about 24 inches, for less dense feedstocks. While density is an important factor in determining the size of the size-reduced feedstock 412, other factors can be considered, such as shape (thin, elongated feedstocks, such as siding, can have a larger size), weight, and desired output size.

The oversized stream 422 can proceed directly, automatically, for example via a conveyor belt, or manually, back into to the size-reduction pre-treatment stage 415, which can be repeated until the desired size of size-reduced feedstock 412 is achieved. The undersized stream 424 can proceed directly, automatically, for example via a conveyor belt, or manually, to the kinetic pulverization stage 430.

Alternatively, the undersized stream 424 can optionally undergo a magnetic separation pretreatment stage 450A with a magnetic or ferrous separator 452 to remove ferrous particulates 454 (i.e., at least a portion of the infrangible component) in the undersized stream 424. A ferrous-reduced undersized stream 456 can then proceed directly, automatically, for example via a conveyor belt, or manually to the kinetic pulverization stage 430.

The undersized stream 424 and/or the ferrous-reduced undersized stream 456 are provided to the kinetic pulverization stage 430 to produce a pulverized output stream 432. In some implementations, the pulverized output stream 432 is subjected to a post-treatment separation stage 420B. In the exemplary implementation, the post-treatment separation stage 420B is a size-based separation stage, for example using one or more screens, for example in parallel, having a desired size. In some implementations, the kinetic pulverization stage 430 is configured to air strip the binder component from the fiber component and pulverize the binder component while leaving the fiber component substantially non-size reduced. In such implementations, the post-treatment separation stage 420B is configured to separate the fiber component that has been air stripped of all or most of the broken-down binder component as an oversized stream 434 from the pulverized binder component as an undersized stream 436. In some implementations, the oversize stream 434 and/or the undersized stream 436 can then be used in subsequent product manufacturing or sold as a recycled component for use in manufacturing other items, including fiber-reinforced materials. Alternatively, if the post-treatment separation stage 420B is configured to separate out larger pieces of the pulverized output stream 432 that require a subsequent kinetic pulverization stage 430, the oversized stream 434 can be redirected to the kinetic pulverization stage 430 and the undersized stream 436 can undergo a second post-treatment separation stage 420B using a screen configured to isolate the fiber component from the pulverized binder component.

In some implementations, the pulverized output stream 432 can undergo multiple post-treatment separation stage 420B, for example in parallel, to isolate different sized fractions of the pulverized output stream 432. One or more of the post-treatment separation stage 420B can be density-based to isolate the fiber component from the binder component based on density, for example using a float pool. For example, the pulverized output stream 432 can be subjected to a size-based post-treatment separation stage 420B to isolate an oversized stream 434 that requires one or more subsequent kinetic pulverization stages 430 and an undersized stream 436 that includes both the fiber component and the pulverized binder component. The undersized stream 436 can then be subjected to a density-based (or size-based) post-treatment separation stage 420B to isolate the fiber component from the binder component.

Depending on the type and quality of the original feedstock 410, the oversized stream 434, the undersized stream 436, and/or the density separated streams (not shown) can optionally include small pieces of infrangible material. In some implementations, the pulverized output stream 432, the oversized stream 434, and/or the undersized stream 436 can be subjected to a post-treatment magnetic separation stage 450B to produce a ferrous-depleted output stream 442, a ferrous-depleted oversized stream 444, and/or a ferrous-depleted undersized stream 446, respectively. The ferrous-depleted output stream 442, the ferrous-depleted oversized stream 444, and/or the ferrous-depleted undersized stream 446 can then be used in subsequent product manufacturing or sold as a recycled component for use in manufacturing other items.

### Feedstocks

### Materials Having a Low Softening Temperature

Various manufacturing feedstocks can be subjected to the kinetic pulverization stage to produce target size-reduced products. Certain manufacturing waste feedstocks and their characteristics will be described in further detail below.

Manufacturing waste refers to a waste stream generated during the manufacturing of a product, such as building materials, such as bricks, resilient flooring, tiles, etc. or consumer products, such as plastic toys, household items, etc. For example, when the manufacturing process includes injection moulding, the manufacturing waste can include injection moulding waste, for example from the sprue, the runners, the gate locations, and/or flash overflow material that leaks from the cavity. The manufacturing waste can also include reject waste that includes improperly formed or broken products or other types of defective products. The reject waste can be automatically separated from the manufactured products stream into a manufacturing waste stream, for example via reject separators or laser separators, or can be visually inspected and manually separated into a manufacturing waste stream. In other implementations, the manufacturing waste can include consumer waste products, such as recalled items or returned product.

In some implementations, the feedstock 10 can include post-consumer waste of a manufactured product, such as used building materials, which can be sourced from a distinct post-consumer waste stream (such as, a single used product) or can be separated from a broader post-consumer waste stream, such as general waste (municipal or landfill waste) or construction and demolition debris. For example, when the post-consumer waste includes used resilient flooring products (in other words, resilient flooring that has been installed as a floor and removed at the end of its use life), the feedstock can come directly from the used resilient floor that was removed or can be separated from a general waste stream or a construction and demolition debris stream in a pre-sorting stage.

In some implementations, the feedstock 10 has at least a concentration of at least 10%, 15%, 20%, 30%, 40%, 50%, or higher of a material having a melting point or softening temperature of 80° C. or more. In some implementations, the feedstock 10 has a concentration of at least 10%, 15%, 20%, 30%, 40%, 50%, or higher of a material having a melting point or softening temperature of 90° C. or less, 100° C. or less, 110° C. or less, 120° C. or less, or 130° C. or less.

In some implementations, the feedstock 10 can be dry feed material that contains little to no moisture. The feedstock 10 can be fed directly to the kinetic pulverization stage 16 without pre-treatment, such as surface wetting pre-treatment to reduce dust. In other implementations, the feedstock 10 can be wet feed material that is fed directly to the kinetic pulverization stage 16 without pre-treatment, such as drying pre-treatment, as the kinetic pulverizer is capable of effectively handling wet or dry feed material. For example, the feedstock can have a moisture content of up to 50% or between 10% and 40%, and can be fed directly into the kinetic pulverizer without pre-drying or pre-wetting. For wetter feedstocks having a moisture content over 50%, a pre-drying step can be performed to dry the material below 50%. For drier feedstocks having a moisture content of less than 10%, a surface wetting step can be performed to reduce the amount of dust produced during the kinetic pulverization stage 16.

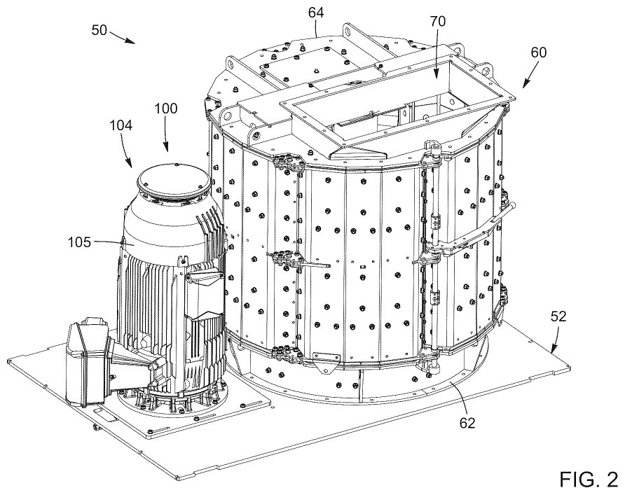

Referring now to FIG. 2, in some implementations, the kinetic pulverizer 50 can be optimized for a specific type of waste having a low softening temperature. For example, the size and geometry of the inlet 70 and/or the housing 60 of the kinetic pulverizer 50 can be a factor in determining the size of the feedstock. In some implementations, the feedstock is pre-crushed or size reduced prior to the kinetic pulverization stage 16. In some implementations, the density of the infeed material can be a factor in determining the size and/or infeed rate of the feedstock. For example, the infeed rate of the feedstock can be varied to account for the density of the feedstock, such that lower density feedstock can be fed into the kinetic pulverizer at a faster infeed rate than higher density feedstocks.

### Resilient Flooring

In some implementations, the manufacturing waste includes the reject waste from manufacturing resilient flooring. Resilient flooring refers to engineered polymer floors. Resilient flooring can have one or more layers, such as a wear layer, a core layer, a bottom layer, a decorative layer, and a protective layer. The layers can consist of a single material or be a composite mixture of two or more materials. The materials that make up the layers of the resilient flooring can include materials such as polyvinyl chloride (PVC), limestone, fillers (such as aggregates, cement, sand, crushed rock, etc.), rubber, asphalt, and organic materials (such as solidified linseed oil, pine resin, cork, sawdust, mineral fillers, etc.).

In some implementations, the resilient flooring is luxury vinyl tile flooring (LVT), which can include a wear layer, a core layer, a bottom layer, and a decorative layer. The LVT flooring can include PVC, filler, such as limestone, and pigments that are manufactured into a flat sheet using heat and pressure.

In other implementations, the resilient flooring can be stone polymer composite (SPC) flooring, which can also be referred to as solid polymer composite flooring. SPC flooring includes a rigid core that imitates the feel of hard-surface floors, like hardwood and stone. In some implementations, the rigid core includes a stone plastic composite, such as PVC and limestone, that is formed without foaming agents to form an ultra-dense core.

The resilient flooring can come in any size and shape, including in tile form (i.e., about 12 inches (12″) by 12″, 12″×24″, 16″×16″, 18″×18″, etc.), plank form (i.e., about 6″, 8″, or 10″ by 48″, 60″, or 72″), or slab form (i.e., about 24″ or 36″ by 36″ or 48″).

### Thermoplastics

In some implementations, the manufacturing waste can include reject waste from manufacturing products with a concentration of at least 10%, 15%, 20%, 30%, 40%, 50%, or higher of material having a melting point or softening temperature of 80° C., 90° C., 100° C., 110° C., 120° C., or 130° C. or less. In some implementations, the material having a melting point or softening temperature of 80° C., 90° C., 100° C., 110° C., 120° C., or 130° C. or less is thermoplastic. For example, toys, drinking bottles, food storage containers, sports equipment, automobile parts, etc. including high concentrations of thermoplastics. In this context, thermoplastics refers to plastic polymers that become pliable or mouldable at higher temperatures and solidify when cooled. As such, convention size reduction of products with a higher percentage of thermoplastics can be difficult as the thermoplastics become pliable, which can cause gumming on the internals of the size reduction machine.

The kinetic pulverization stage described herein provides airflow currents that reduce the internal temperature of the kinetic pulverizer to thereby prevent, at least in part, the material having a low softening temperature, such as thermoplastics, from becoming pliable and thus allowing their size reduction. In some implementations, the kinetic pulverizer can be operated such that the internal temperature does not exceed the minimal melting or softening temperature of the material having a melting point or softening temperature of 80° C., 90° C., 100° C., 110° C., 120° C., or 130° C. or less. In some implementations, the kinetic pulverizer can be operated such that the internal temperature does not exceed 80° C., 90° C., or 100° C. For example, the kinetic pulverizer can be operated such that the internal temperature does not exceed 105° C., which is the melting temperature of low-density polyethylene (LDPE), or does not exceed 85° C., which is the melting temperature of PVC. In the exemplary implementation, the airflows generated in the kinetic pulverizer act to reduce the internal temperature of the kinetic pulverizer such that the internal temperature does not exceed 93° C. (about 200° F.). For feedstocks that include a mixture of components, such as PVC and limestone, having an internal temperature of less than about 93° C. prevents the thermoplastic component in the feedstock from softening or melting, thus increasing the efficiency of the size reduction.

Thermoplastics can be re-melted and re-used multiple times, thus allowing mis-manufactured items (i.e., reject waste), manufacturing waste, and/or post-consumer waste to be separated out, size reduced and separated, and reintroduced into the manufacturing process. Examples of thermoplastics include, without limitation, polypropylene, polyethylene, polyvinyl chloride, polystyrene, polyethylene terephthalate, polycarbonate, and acrylonitrile butadiene styrene (ABS).

### Asphalt Shingles

In some implementations, the waste stream can be manufacturing rejects of asphalt shingles and/or post-consumer waste asphalt shingles (i.e., used asphalt shingles at the end of their use life). When processed using conventional size-reduction machinery, the asphalt can become molten, resulting in higher energy requirements to size reduce the asphalt shingles. Furthermore, some types of asphalt shingles include a chemical sealant that is activated by solar warmth to activate and seal the shingles on the roofing surface. When activated by solar warmth, the chemical sealant gets sticky or tacky and creates a strong bond between the roofing surface and the shingles. The airflow created by multiple overlapping vortices in the kinetic pulverization stage, which causes self-collisions of the asphalt components of the shingles, reduces an internal temperature of the kinetic pulverizer when compared with conventional machines. Moreover, the temperature of the shingles being processed does not increase as quickly in the kinetic pulverizer as with conventional machines, as the size reduction is largely due to matter on matter impacts between the shingles, as opposed to the internal components of the machine contacting the material. Accordingly, the kinetic energy transfer is between particles of the material being size reduced (shingles) and not between the internal components of the kinetic pulverizer and the material, which reduces the amount of heat being generated internally.

### Fiber-Reinforced Materials

Various fiber-reinforced feedstocks can be subjected to the kinetic pulverization to produce target size-reduced products. Certain fiber-reinforced feedstocks and their characteristics will be described in further detail below.

In some implementations, the fiber-reinforced material can include fiber-reinforced composites, such as polymer matrix composites (PMCs). The PMC can include a binder component that includes any known thermoset, thermoplastic, and/or elastomeric resin that is embedded with any type of fiber, including carbon fibers, organic fibers (hemp, cotton, coir, silk, etc.), metal fibers, polypropylene fibers, nylon fibers, and/or glass fibers. For example, the fiber-reinforced feedstock can include at least a portion of fiberglass comprising a binder component and a glass fiber component. The fiberglass is subjected to the kinetic pulverization stage to isolate the binder component used to form the fiberglass. During the process, the glass fiber component can also be isolated. In some implementations, the binder component can include a polyester resin, a vinyl resin, and/or an epoxy resin. The binder component can, optionally, include a catalyst to cure or harden the binder component (such as methyl ethyl ketone peroxide (MEKP)) and/or a hardener.

In some implementations, the fiber-reinforced feedstock can include fiber-reinforced concrete. The fiber-reinforced concrete includes a concrete matrix component and a fiber component, such as carbon fibers, organic fibers (hemp, cotton, coir, silk, etc.), metal fibers, polypropylene fibers, nylon fibers, and/or glass fibers.

In some implementations, the fiber-reinforced feedstock can include textiles, such as carpet products (carpet, rugs, etc.) or textiles including a binder component, such as acrylic resins, urethane resins, thermoplastics, latex, or epoxy resins. For example, when the feedstock is carpet or rugs, the fiber component can include synthetic fibers, such as nylon fibers, polyester fibers, polypropylene fibers (olefin fibers), polyester fibers, and/or polytrimethylene terephthalate (PTT) fibers (triexta fibers), and/or organic fibers, such as sisal fibers, cotton fibers, and/or wool fibers. The fibers are woven into a backing material that comprises the binder component, such as thermoplastics, including polypropylene and/or polyvinyl chloride (PVC), polyurethane, and/or latex.

In some implementations, the feedstock 10 can be dry feed material that contains little to no moisture. The feedstock 10 can be fed directly to the kinetic pulverization stage 16 without pre-treatment, such a pre-treatment stage, such as surface wetting pre-treatment to reduce dust. In other implementations, the feedstock 10 can be wet feed material that is fed directly to the kinetic pulverization stage 16 without pre-treatment, such as drying pre-treatment, as the kinetic pulverizer is capable of effectively handling wet or dry feed material. For example, the feedstock can have a moisture content of up to 50% or between 10% and 40%, and can be fed directly into the kinetic pulverizer without pre-drying or pre-wetting. For wetter feedstocks having a moisture content over 50%, a pre-drying step can be performed to dry the material below 50%. For drier feedstocks having a moisture content of less than 10%, a surface wetting step can be performed to reduce the amount of dust produced during the kinetic pulverization stage 16.

In some implementations, the fiber-reinforced feedstock 10 can include post-consumer waste of a manufactured product, such as used building materials (ex., fiber-reinforced concrete siding or planks, used carpet or rugs, etc.), which can be sourced from a distinct post-consumer waste stream (such as, a single used product) or can be separated from a broader post-consumer waste stream, such as general waste (municipal or landfill waste) or construction and demolition debris. For example, when the post-consumer waste includes used products composed at least in part of a fiber-reinforced material, such as siding, carpet or wind turbine blades, (in other words, products comprising fiber-reinforced material that have been installed or used in their conventional manner and removed at the end of their use life), the feedstock can come directly from the used product that was removed or can be separated from a general waste stream or a construction and demolition debris stream in a pre-sorting stage.

In some implementations, the feedstock 10 has a concentration of at least 10%, 15%, 20%, 30%, 40%, 50%, or higher of a fiber-reinforced material. In some implementations, the feedstock 10 is entirely composed of fiber-reinforced material or has a concentration of fiber-reinforced material that is at least 70%, 80%, 90%, 95%, or 99% fiber-reinforced material.

In some implementations, the size and geometry of the inlet 70 and/or the housing 60 of the kinetic pulverizer 50 can be a factor in determining the size of the feedstock. In some embodiments, the feedstock undergoes a size-reduction pre-treatment stage to pre-crushed or size reduce the feedstock prior to the kinetic pulverization stage 16. In some implementations, the density of the infeed material can be a factor in determining the size and/or infeed rate of the feedstock. For example, the infeed rate of the feedstock can be varied to account for the density of the feedstock, such that lower density feedstock, such as fiberglass, can be fed into the kinetic pulverizer at a faster infeed rate than higher density feedstocks, such as fiber reinforced cement.

### Fibrous Materials

In some implementations, the feedstock can be a fibrous material, such as portions of plant materials, including hemp, cotton, and flax. In some implementations, the fibrous material can be in its raw form, such as hemp or flax straw, can be a waste by-product of a manufacturing processing using the fibrous material, and/or can be a product formed from the fibrous material, such as textiles, organic plastic materials, or paper. In some implementations, the fibrous material can be processed as described herein and/or in a similar manner to fiber-reinforced materials. For example, textiles made from hemp (which can also be considered a fiber-reinforced material) can be processed using the kinetic pulverization stage to reduce the feedstock to its base monomers and isolate the fibers for fiber to fiber recycling. In some instances, the textiles can include multi-fiber blended fabrics and the processes described herein can be used to isolate the types of fibers from each other and separate them for secondary use purposes. In some implementations, such as when the feedstock is an organic plastic material formed from a fibrous material (which can also be considered a fiber-reinforced material), the processes described herein can be used to isolate a fiber component therein from the respective binder component that makes up the organic plastic material.

### Pre-Treatment Stages

Prior to the kinetic pulverization stage 16, there can be a number of upstream pre-treatment stages that can treat the feedstock 10. For example, an upstream separation stage comprising upstream mechanical screening to pre-sort the feedstock 10 by size and/or upstream magnetic separation can pre-sort the feedstock to remove at least a portion of the infrangible material prior to the kinetic pulverization stage 16. In some implementations, an automatic or manual pre-sorting stage can be used to isolate the feedstock from a larger stream of materials, such as a waste stream. When the feedstock includes large and/or dense components, the feedstock can undergo a size-reduction pre-treatment stage, for example using manual equipment, such as saws, or conventional size-reduction materials, such as grinders, crushers, etc. The size-reduction pre-treatment stage can be used to size reduce the feedstock into an acceptable size for the inlet 70 and/or the housing 60 of the kinetic pulverizer 50.

In some implementations, for example, when the feedstock is subjected to a size-reduction pre-treatment stage, an upstream dust collection stage can pre-sort the feedstock to remove dust. In other embodiments, the upstream separation stage can comprise manual sorting to remove materials in the feedstock that can be sold as an end product or undergo a separation processing stage.

### Kinetic Pulverization Stage

Regarding the kinetic pulverization stage 16, a single kinetic pulverizer can be implemented and operated as a one-pass stage. For example, the feedstock can be fed into an upper part of the kinetic pulverizer, which includes a drum with baffles and an internal rotating shaft with multiple arms that create vortexes within the drum chamber. The feed material passes into the vortices and experience self-collision for size reduction of the entire feedstock 10, or optionally, of a frangible material within the feedstock 10 while, optionally, leaving the ductile material oversized and not significantly size reducing the infrangible material. Accordingly, when the feedstock 10 includes materials with a frangible material connected to a ductile material (such as shingles having asphalt embedded in a fiberglass or organic mat backing), the kinetic pulverization stage 16 can facilitate the liberation of the frangible material (asphalt) from the ductile material (fiberglass or organic backing).

As another example, a fiber-reinforced material can pass into the vortices and experience self-collision for size reduction of, primarily the binder component in the fiber-reinforced material, and the airflow created by the vortices acts to airstrip the binder component from the fiber component. Thus, depending on the type of fiber in the fiber-reinforced feedstock, the ductile fiber component is often not significantly size-reduced and the frangible binder component is pulverized and removed from the fiber component. Accordingly, when the feedstock 10 includes materials with a frangible binder material connected to a ductile fiber material, the kinetic pulverization stage 16 can facilitate the liberation of the ductile binder component from the frangible fiber component, thus isolating each of the constituent parts of the fiber-reinforced material, for example for subsequent use in producing new fiber-reinforced materials.

The kinetic pulverization stage 16 uses kinetic energy, vortices and matter-on-matter collisions to achieve size reduction of the entire feedstock 10 or of a frangible material within the feedstock 10, and, optionally, liberation of the ductile material. In some implementations, air stripping can achieve size reduction of the binder component and isolation of the fiber component from the binder component.

The airflow generated by the vortexes can act to reduce an internal temperature of the kinetic pulverizer. Furthermore, with conventional size-reduction machines, such as grinders, crushers, or hammer mills, the size reduction occurs due to internal components of the machine repeatedly coming into contact with the material. A gradual increase in the internal temperature of the conventional machines results from these multiple points of contact between the internal components of the machine and the material being size-reduced, which leads to the material softening or melting. When the material softens, melts, or even burns, the energy requirement to run the machine increases and the final product is degraded. In contrast, the overlapping vortices created by the kinetic pulverizer cause self-collisions of the particulates being size reduced (i.e., matter on matter impacts). These particle self-collisions cause an increase in temperature at a much slower rate than mechanical machinery that depend on machine to material impacts. Accordingly, in addition to the airflow generated by the rotating arms acts to reduce the internal temperature of the kinetic pulverizer, the size-reduction by self-collisions causes a much slower rate of heat production internally within the kinetic pulverizer. As such, the kinetic pulverization stage 50 can be conducted as a “dry” process where no water or other coolant liquid is added to the kinetic pulverizer while it is operating.

In some implementations, the feedstock can be subjected to one or more subsequent kinetic pulverization stages to increase the separation between the fiber component and the binder component. The kinetic pulverizer can be operated to optimize a resident time of the fiber-reinforced material in the kinetic pulverizer. For example, materials that have a very strong binder component, such as wind turbine blades, may require longer resident times in the kinetic pulverizer than materials made with a weaker binder component, such as consumer products made with fiber-reinforced composites. Having a longer resident time in the kinetic pulverizer can increase the isolation of the fiber component from the binder component. In some implementations, as the strength of the binder component increases, the resident time or number of kinetic pulverization stages can be increased to provide separation of the fiber component and the binder component.

In some cases, the process, kinetic pulverization stage 16 and/or kinetic pulverizer 50 can be operated in continuous mode or in semi-batch mode. It is also possible to pulverize the material in a single pass or using multiple passes through the kinetic pulverizer 50. When multiple passes are used, the pulverized material from a first pass can be screened and only a fraction, such as an oversized fraction, can be fed through a subsequent pass. More generally, certain materials or fractions can be subjected to multiple pulverization stages, which may be done in the same kinetic pulverizer 50 via recycling or in multiple kinetic pulverizers 50 operated in series. The material can be batch fed or continuous fed into the kinetic pulverizer 50. Each pass through the kinetic pulverizer 50 may be done at the same or different operating conditions (e.g., rotation speed, feed rate) where variations in operating conditions are determined based on the composition of the feed for each pass, for example.

The material passes to a bottom region of the kinetic pulverizer 50 and is expelled via a lower outlet as the pulverized output stream 18. The kinetic pulverizer can be operated with a rotation speed between 500 RPM to 1,200 RPM or between 600 RPM and 1,100 RPM or between 700 RPM and 1,000 RPM. The rotation speed can be adjusted in response to other process parameters or maintained relatively constant. In some implementations, the rotation speed is adjusted to control the size and/or quality of the output material. In some implementations, the rotation speed is adjusted or varied to liberate the ductile material from the frangible material.

In some implementations, the rotation speed is adjusted or varied based on the density of the feedstock. For example, higher density feedstocks, such as fiber-reinforced concrete, can be size reduced with a lower rotational speed so as to produce larger aggregate pieces of fiber-reinforced concrete, or can be size reduced with a higher rotational speed to pulverize the feedstock and achieve a smaller particle size.

The kinetic pulverization stage can not only enable targeted size reduction of the feedstock, but can also facilitate drying and/or pathogen reduction for a higher quality output stream. In some implementations, the pulverizing stage reduces the moisture by 5 to 8% and then the separation stage enables the size-reduced fraction to have a further lowered moisture content.

### Separation Stage

When the kinetic pulverization stage is optimized to separate the ductile material from the frangible material, the separation stage 20 can selectively remove the ductile material, which is oversized material, from the pulverized output stream 18. Oversized material includes the lower density, flexible fraction of feedstock (i.e., ductile material) and/or infrangible materials, such as metal. When the oversized material includes infrangible materials, the pulverized output stream 18 can be subjected to a magnetic separation stage. The oversized fraction can be substantially composed of the ductile materials, including plastic and paper films or fibers, which can be separated from the frangible material via size separation techniques, such as screening.

As described above, the oversized fraction can then be separated from the size-reduced fraction using a size-based separation technique, such as screening. The screening can be performed using various types of mechanical screens, such as a vibrating screen, a tumbler screen, a trommel screen, a gyratory screen, and/or high-frequency screen, among others. The mechanical screen can be configured or operated based on the composition and size distribution of the pulverized output stream 18 to favour separation of the size-reduced and oversized fractions from each other. The screen can be provided to favour or maximize high purity or high yield of the oversized stream 24 (e.g., fiber component), or to favour other parameters related to the size-reduced stream 22 (e.g., binder component) and/or the oversized stream 24. The size-reduced stream 22 and/or the oversized stream 24 can then be subjected to further processing and recovery, if desired.

In other implementations, as described above, density-based separation techniques, such as magnetic density separation, magnetic float sinks, float sinks, gravity separation, and/or hydrocyclone separators can be utilized to separate the fiber component from the binder component. Alternatively, optical separation techniques, such as laser separation or colour-based separation can be utilized.

In some implementations, such as when the fiber-reinforced material includes a metal fiber component, the separation stage 20 includes a magnetic separation stage to isolate the fiber component. For example, some types of fiber-reinforced concretes can include metal fibers that can be isolated from the pulverized concrete binder component using magnetic separation.

In some implementations, the infrangible materials can comprise small fragments that cannot be removed via mechanical screening (i.e., small metal particulates that are homogenized with the pulverized frangible material) or density separation. The separation stage 20 can include a metal separation stage upstream and/or downstream of the kinetic pulverization stage 16 and/or the mechanical screening. When the infrangible material is embedded within a frangible material, for example, metal fasteners embedded in fiber-reinforced concrete, the kinetic pulverization stage 16 can liberate the infrangible material, to allow separation during a downstream magnetic separation stage 20. Whereas an upstream magnetic separation stage may be required to remove large infrangible materials that could cause damage to the kinetic pulverizer, such as fasteners or strapping for fiber-reinforced building materials. In some implementations, the feedstock 10 is subjected to an upstream metal separation stage that substantially depletes the feedstock 10 of any infrangible materials.

In some implementations, the separation stage 20 and the pulverization stage 16 are coordinated such that the operation of one can influence the other. For example, the screen and the pulverizer can be monitored and controlled via a controller 26 to achieve a desired parameter, such as certain properties of the size-reduced stream 22 and/or the oversized stream 24. For example, if a change in the input feedstock results in the pulverizer generating a larger size-fraction in the pulverized stream 18, the screen can be controlled accordingly to favour a certain desired separation. In addition, the kinetic pulverizer can be controlled, e.g., to increase the rotation speed by controlling the motor 28 or to reduce the infeed rate by controlling the infeed conveyor, to bring the size-reduced fraction back to within a target range to facilitate a desired separation.

Monitoring instrumentation, such as an inlet detector D_{I} 30 and an outlet detector D_{O} 32, can be provided to monitor properties of the streams (e.g., size distribution, composition, moisture content, mass, and/or volume flow rates). Depending on the size-reduced product to be produced, the screen and the kinetic pulverizer can be operated and designed in certain ways to generate a specific product, such as an end product having a maximum size. It is noted that the screen design can be market driven to provide various size distributions of the size-reduce material.

In some implementations, the various streams are transported between stages using conveyor systems to facilitate continuous operation, although other transport methods can be used. The process can be continuous, batch feed, or operated according to other schemes depending on the facility and other factors.

### Materials Having a Low Softening Temperature

Regarding the pulverized output stream 18, in some implementations the pulverization stage 16 generates material that ranges from less than 500 μm to about 1,600 μm. In some implementations, at least 60%, at least 70% or even over 80% of the pulverized output stream 18 passes through a 35 US mesh (500 μm or 0.0197 inches). In some implementations, at least 70%, at least 80%, at least 90%, or ever 100% of the pulverized output stream 18 passes through a 3 or 4 US mesh (0.0630 inches or 1600 μm).

### Fiber-Reinforced Materials

Regarding the pulverized output stream 18, in some implementations the pulverization stage 16 generates material that ranges from silt or dust-sized particles to larger particles, with the majority (e.g., over 50% or between 50% and 70% or even over 90%, 95% or 99%) passing a ¼ inch screen. For example, in some implementations, between 85% to 100% of the pulverized output stream 18 can pass through a 6.3 mm (¼ inch) screen, with over 50% of the pulverized output stream passing through a 3 mm screen. The oversized stream can include the flexible fiber fraction of feedstock (i.e., ductile material) and the infrangible material, while the undersized stream includes the pulverized frangible binder component, which is often brittle, hard, and friable.

### Kinetic Pulverizer

The kinetic pulverizer can have various structural and operational features. It some implementations, the kinetic pulverizer can have one or more features as described in PCT/CA2019/050967, which is incorporated herein by reference.

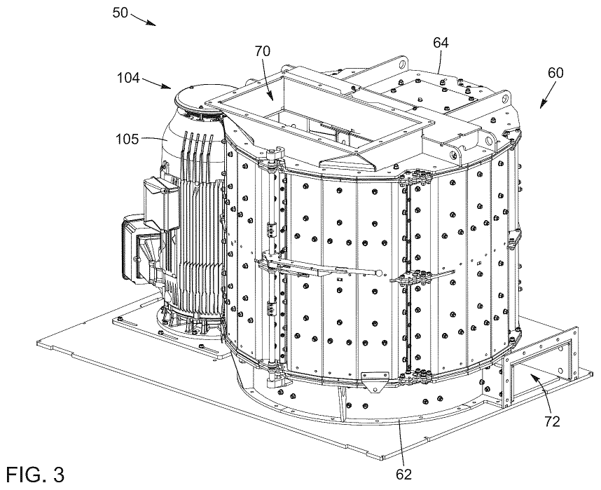

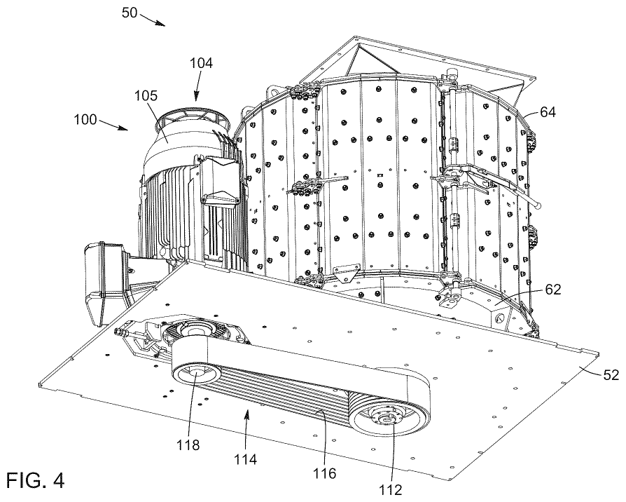

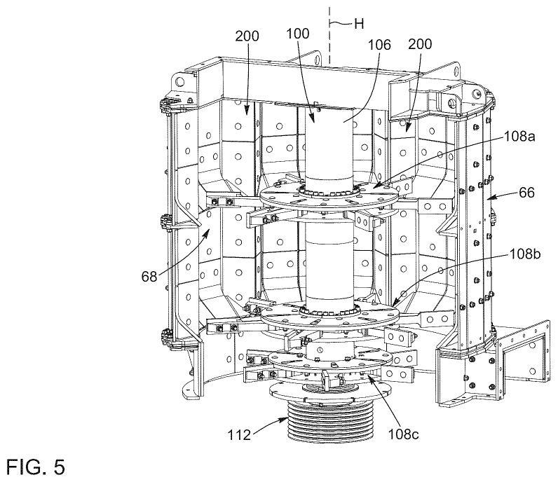

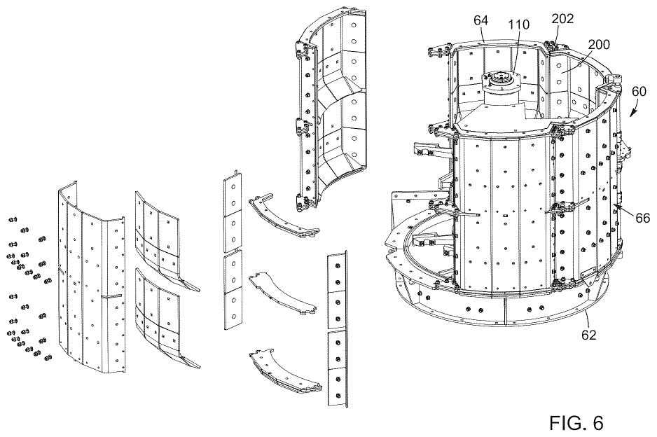

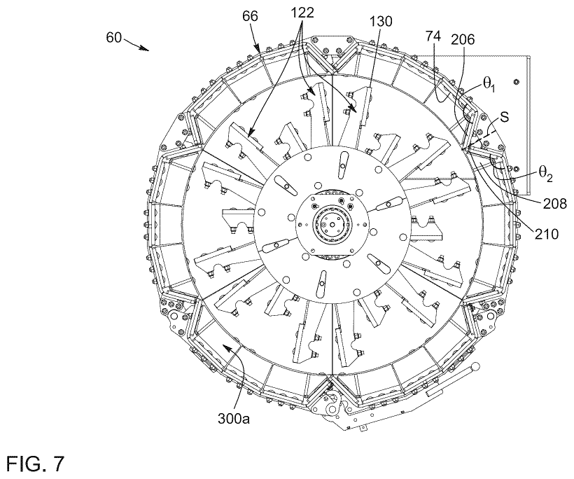

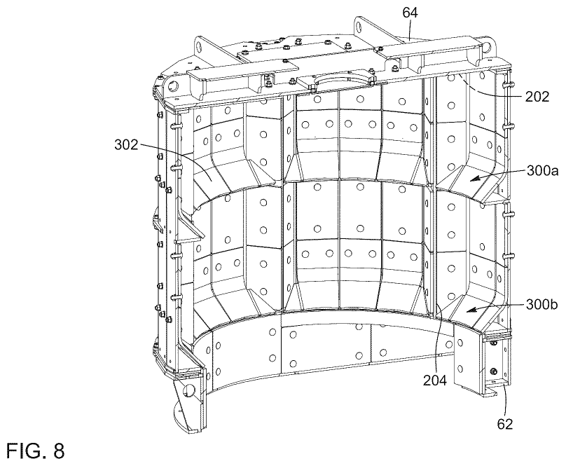

Referring now to FIGS. 2 to 10, there is shown a pulverizer 50, in accordance with one implementation. The pulverizer 50 is adapted to receive an input material as described herein and to pulverize or comminute the input material.

It will be understood that the terms “pulverize”, “pulverization”, “comminute” and “comminution” are used herein to refer to a reduction in size of the particles in the input material.

In the illustrated implementation, the pulverizer 50 includes a base 52 and a housing 60 mounted over the base 52. Specifically, the housing 60 includes a bottom end 62 connected to the base 52 and a top end 64 opposite the bottom end 62. The housing 60 is hollow and includes a housing sidewall 66 extending between the top and bottom ends 64, 62 to define an interior chamber 68 in which the pulverization occurs. Specifically, the housing 60 includes an inlet 70 located at the top end 64 to receive the input material and an outlet 72 located at the bottom end 62 through which the pulverized material may be discharged once having been pulverized in the interior chamber 66.

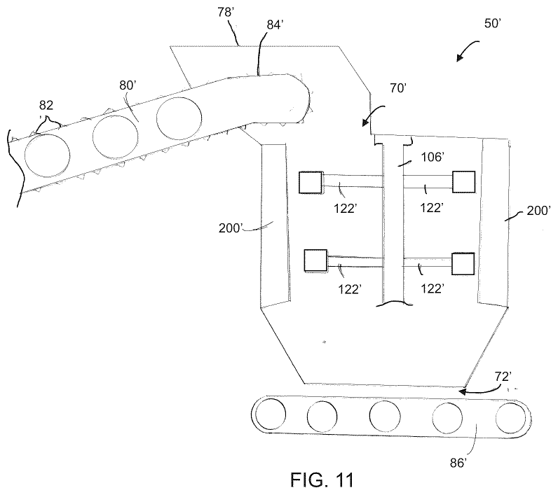

In the illustrated implementation shown in FIGS. 2 to 10, the outlet 72 allows pulverized material to be discharged in a tangential direction to the housing sidewall 66. It will be understood that the outlet 72 may be configured differently. For example, the outlet 72 may be located in a bottom face of the housing 60 such that the pulverized material may be discharged in an axial direction downwardly from the housing 60 (as shown in the alternative kinetic pulverizer 50′ shown in FIG. 11). It will also be understood that alternatively, the outlet 72 may be positioned substantially towards the bottom end 62 but may not be positioned exactly at the bottom end 62 of the housing 60. Similarly, the inlet 70 may not be positioned exactly at the upper end 64 of the housing 60 and may instead be located generally towards the upper end 64.

In the illustrated implementation, the housing 60 is generally cylindrical and defines a central housing axis H extending between the top and bottom ends 64, 62 of the housing 60. The housing 60 is adapted to be disposed such that the central housing axis H extends substantially vertically when the pulverizer 50 is in operation. In this configuration, the input material fed into the inlet 70 will ultimately tend to fall down towards the outlet 72 by gravity.

In the illustrated implementation, the airflow generator 100 includes a pulverizing rotor assembly 102 disposed within the interior chamber 68 and a rotary actuator 104 operatively coupled to the pulverizing rotor assembly 102 for rotating the pulverizing rotor assembly 102 to generate the airflow, for example, to reduce the internal temperature of the kinetic pulverizer 50 to reduce or prevent the softening of thermoplastics present in the feedstock 10 and/or to to facilitate air stripping, optionally, to assist with the removal/separation of the fiber component from the binder component. Specifically, the pulverizing rotor assembly 102 includes a rotatable shaft 106 located in the interior chamber 68 and extending between the top and bottom ends 64, 62 of the housing 60, along the central housing axis H, and a plurality of pulverizing rotors 108a, 108b, 108c secured to the rotatable shaft 106 so as to rotate about the central housing axis H when the rotatable shaft 106 is rotated.

Each pulverizing rotor 108a, 108b, 108c includes a rotor hub 120 and a plurality of rotor arms 122 extending outwardly from the rotor hub 120 and towards the housing sidewall 66. The rotatable shaft 106 extends through the rotor hub 120 such that the rotor arms 122 are disposed in a rotation plane R which extends orthogonally through the central housing axis H. In this configuration, when the rotatable shaft 106 is rotated, the rotor arms 122 therefore remain in the rotation plane R and move along the rotation plane R. Alternatively, instead of all being disposed in a rotation plane, the rotor arms 122 could instead be angled upwardly or downwardly relative to the rotatable shaft 106. In yet another implementation, the rotor arms 122 could instead be pivotably connected to the rotatable shaft 106 such that the rotor arms 122 could selectively be angled upwardly and downwardly as desired, either manually or automatically using one or more arm actuators.

In the illustrated implementation, the plurality of airflow deflectors 200 includes six deflectors 200 which are substantially similar to each other and which are substantially evenly spaced from each other in an azimuthal direction (i.e. along a circumference of the housing sidewall 66) around the central housing axis H. Alternatively, all the deflectors 200 may not be similar to each other, may not be spaced from each other evenly and/or the pulverizer 50 may include more or less than six deflectors 202. For example, the pulverizer 50 may include between two and eight deflectors 200.

In the illustrated implementation, each deflector 200 is elongated and extends substantially parallel to the housing axis H. Specifically, since the housing 60 is positioned such that the central housing axis H extends substantially vertically, the deflectors 200 also extend substantially vertically.

As best shown in FIGS. 6 to 8, each deflector 200 includes a top end 202 located towards the top end 64 of the housing 60 and a bottom end 204 located towards the bottom end 62 of the housing 60. In the illustrated implementation, each deflector 200 is positioned so as to intersect the rotation plane R of the upper pulverizing rotor 108a and of the intermediate pulverizing rotor 108c. More specifically, the top end 202 of the deflectors 200 is located above the upper pulverizing rotor 108a while the bottom end 204 of the deflectors 200 is located below the intermediate pulverizing rotor 108c, and the deflector 200 extends continuously between its top and bottom ends 202, 204.

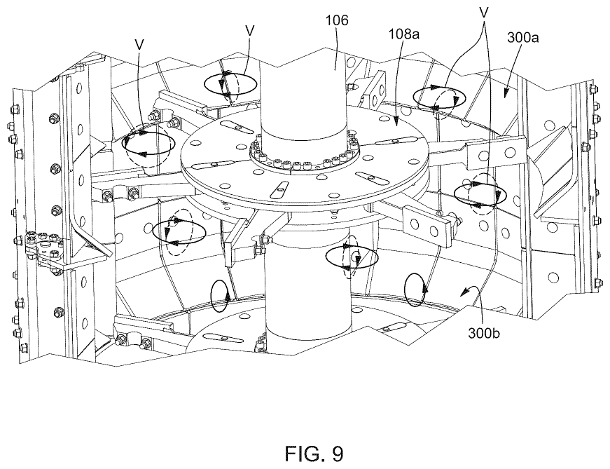

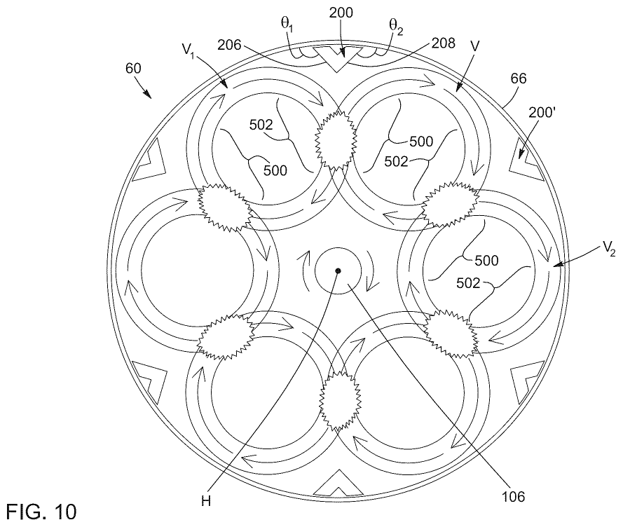

It will be understood that rotation of the rotor arms 122 will cause the air within the interior chamber 68 to move outwardly towards the housing sidewall 66. In the above configuration, since the deflectors 200 are horizontally aligned with the upper and intermediate pulverizing rotors 108a, 108c, the air will be moved outwardly by the upper and intermediate pulverizing rotors 108a, 108c against the deflectors 200 to be deflected by the deflectors 200 to form the vortices V, best shown in FIGS. 9 and 10.

In the illustrated implementation, each deflector 200 is generally wedge-shaped. Specifically, each deflector 200 has a generally triangular cross-section and includes a flow facing deflecting surface 206 which faces towards the airflow when the rotatable shaft 106 is rotated and an opposite deflecting surface 208 which faces away from the airflow. The flow facing deflecting surface 206 and the opposite deflecting surface 208 extend away from the housing sidewall 26 and converge towards each other to meet at an apex 210 which points towards the housing central axis H. The flow facing deflecting surface 206 is angled relative to an inner face 34 of the housing sidewall 26 at a first deflection angle θ1 and the opposite deflecting surface 208 is angled relative to the inner face 74 of the housing sidewall 76 at a second deflection angle θ2.

In the illustrated implementation, each deflector 200 is symmetrical about a symmetry axis S which extends along a radius of the housing 60. In this implementation, the first deflection angle θ1 is therefore substantially equal to the second deflection angle θ2. In one implementation, the first and second deflection angles θ1, 02 may be equal to about 1 degree to 89 degrees, and more specifically to about 30 degrees to 60 degrees. Alternatively, the deflector 200 may not be symmetrical and the first and second deflection angles θ1, 02 may be different from each other.

In the illustrated implementation, the apex 210 of each deflector 200 is spaced radially inwardly from the inner face 74 of the housing sidewall by a radial distance of about 7¾ inches or about 20 cm. Still in the illustrated implementation, the apex 210 is further spaced radially outwardly from a tip 130 of the rotor arms 122 by a radial distance of between abo½½ inch or about 1 cm and about 2 inches or about 5 cm. In one implementation, the radial distance or “clearance space” between the tip 130 of the rotor arms 122 and the apex 210 may be selected such that the vortices V may be formed as desired when the rotatable shaft 106 is rotated.

Alternatively, the deflectors 200 could be differently shaped and/or sized. For example, the flow facing deflecting surface 206 and the opposite deflecting surface 208 may not be planar, but may instead be curved. In another implementation, the deflectors 200 may not comprise an opposite deflecting surface 208. In yet another implementation, instead of being wedge-shaped, the deflectors 200 may instead have a rectangular cross-section, or may have any other shape and size which a skilled person would consider suitable.

FIG. 10 is a schematic representation of the vortices V generated within the interior chamber 68 when the pulverizer 50 is in operation.

During operation of the pulverizer 10, the rotatable shaft 106 is rotated about the housing axis H such that the rotor arms 122 form the circular airflow revolving about the housing axis H. In the example illustrated in FIG. 10, the rotatable shaft 106 is rotated in a clockwise direction when viewed from above to form a counterclockwise airflow in the interior chamber 68.

The rotatable shaft 106 may be rotated at relatively high speed to provide the desired pulverizing effect in the pulverizer. In one implementation, the rotatable shaft 106 is rotated at a rotation speed of between about 500 rpm and about 1200 rpm, and more specifically at a rotation speed of between about 700 rpm and about 1100 rpm, or between about 1000 rpm and about 1100 rpm. Alternatively, the rotatable shaft 106 may be rotated at a different rotation speed that would allow the formation of the vortices as described below. As is understood by the skilled person, the rotation speed of the rotatable shaft 106 can be adjusted to produce a desired particle size of the size-reduced fraction and/or the prevent or reduce size reduction of the ductile and/or infrangible material in the oversized fraction.

The airflow travels generally along the inner face 34 of the housing sidewall 66, but is interrupted by the flow facing deflecting surface 206 of the deflectors 200, which cooperates with the rotor arms 122, and more specifically with the tip of the rotor arms 122 to form the vortices V. As shown in FIG. 10, the vortex V may further be guided back inwardly towards the central housing axis H by an adjacent deflector 200′.

Still referring to FIG. 10, each vortex V further overlaps at least one adjacent vortex V1, V2 to cause input material particles in suspension in the vortex V to collide with input material particles in suspension in the adjacent vortex or vortices V1, V2. More specifically, each vortex V created generally includes an outwardly moving portion 500 defined generally by airflow circulating from the shaft 106 towards the housing sidewall 66 and an inwardly moving portion 502 defined generally by airflow circulating from the housing sidewall 26 towards the shaft 106. As shown in FIG. 10, the outwardly moving portion 500 of each vortex V overlaps the inwardly moving portion 502 of a first adjacent vortex V1, and the inwardly moving portion 502 of each vortex overlaps the outwardly moving portion 500 of a second adjacent vortex V2.

In this configuration, the input material particles in the vortex therefore collide with input material particles moving at twice the movement speed of the particles in the vortex V. For example, in one implementation, the vortices V, V1, V2 are rotating at about a third of the speed of sound. When input material particles from the first and second adjacent vortices V1, V2 collide with the input material particles in suspension in the vortex V, which move at the same speed but in the opposite direction, the particles will collide with each other at about two thirds of the speed of sound.

In one implementation, in addition to the collision of the input material particles via the airflow and vortices V, the input material may further be pulverized by the rotor arms 122 impacting the input material particles in the interior chamber 68 as the rotatable shaft 106 is rotated. In this implementation, the combined effect of the input material particles impacting each other in the overlapping vortices V, V1, V2 and of the rotor arms 122 impacting the input material particles may increase the efficiency of the pulverizer. Moreover, since the overlapping vortices V cause the particles to impact each other rather than surfaces inside the housing 20, the wear of the components inside the housing 20 may be reduced.

It will be understood that the vortices V illustrated in FIGS. 9 and 10 have been simplified for ease of understanding and that in practice, the vortices V may not be exactly circular as illustrated or be exactly located as indicated in FIG. 10.

In the illustrated implementation, the pulverizer 50 further includes a plurality of shelves 300a, 300b which extend inwardly from the housing sidewall 26. Specifically, the plurality of shelves 300a, 300b includes an upper shelf 300a and a lower shelf 300b spaced downwardly from the upper shelf 300a. Each shelf 300a, 300b extends circumferentially around the housing axis H and along the housing sidewall 26. It will be understood that the shelves therefore extend substantially orthogonally to the deflectors 200. Specifically, the deflectors 200 extend generally parallel to the housing axis H and can therefore be said to extend in an axial direction relative to the housing 60, while the shelves can be said to extend in an azimuthal direction relative to the housing 60. In the illustrated implementation, the deflectors 200 extend generally vertically while each shelf 300a, 300b is disposed in a generally horizontal plane and therefore extend generally horizontally.

Still in the illustrated implementation, each shelf 300a, 300b extends substantially continuously around the housing sidewall 66. Alternatively, the shelves 300a, 300b may not extend continuously around the housing sidewall 66 and could instead include a plurality of shelf segments spaced from each other to define gaps between adjacent shelf segments.

In the illustrated implementation, the upper shelf 300a is substantially horizontally aligned with the upper pulverizing rotor 108a and the lower shelf 300b is substantially horizontally aligned with the intermediate pulverizing rotor 108c. Alternatively, each shelf 300a, 300b could be located slightly below the corresponding pulverizing rotor 108a, 108c.

In the illustrated implementation, each shelf 300a, 300b includes a top shelf face 302 which extends downwardly and away from the housing sidewall 66. Specifically, since the shelf 300a, 300b extends along the housing sidewall 66 and around the housing axis H, the top shelf face 302 is substantially conical. Still in the illustrated implementation, the top shelf face 302 is angled relative to the housing sidewall 66 at an angle of between about 1 degree, where the top shelf face 302 would be almost flat against the housing sidewall 66, and about 89 degrees, where the top shelf face 302 would be almost orthogonal to the housing axis H. In one implementation, the top shelf face 302 could be angled relative to the housing sidewall 66 at an angle of between 30 degrees to 60 degrees.

The shelves 300a, 300b are configured to deflect the airflow directed towards the shelf upwardly. This allows the input material particles to be temporarily maintained in suspension above the shelf 300a, 300b. The input material particles can therefore be subject to the effect of the vortices and to pulverization by impact with the rotor arms 122 for a longer period of time, resulting in additional reduction in the size of the input material particles as they travel downwardly towards the next rotor stage or towards the outlet 72.

The upward deflection of the airflow may further contribute to the vortices V within the interior chamber 68. More specifically, as shown in FIG. 9, the vortices V may rotate in a plane generally parallel to the housing axis, i.e., upwardly-downwardly, in addition to rotating in a plane orthogonal to the housing axis H as illustrated in FIG. 10. The combined effect of the shelves 300a, 300b and the deflectors 200 therefore contribute to forming vortices V which are tridimensional such that air within the vortices V moves along a tridimensional path of travel, which may further promote collisions between the input material particles of adjacent, overlapping vortices V.

This configuration further allows the number of vortices V generated by the deflectors 200 to be multiplied by the number of shelves 300a, 300b in the housing 60. For example, in the illustrated implementation, the pulverizer 50 includes six deflectors 200 which can form six vortices above each shelf 300a, 300b, for a total of 12 vortices in the entire interior chamber 68.

The pulverizer can be designed and sized to handle the feedstock for one-pass processing. For example, the pulverizer can be sized to handle 5 to 20 tonnes per hour, or 10 to 15 tonnes per hour, of a manufacturing waste stream that comprises a mixture of components as described above or a fiber-reinforced material stream that comprises a fiber component and a binder component, while operating as a one-pass unit with a rotation speed between 500 RPM and 1,200 RPM to produce one or more of the output sized streams as described herein.

Referring now to FIG. 11, a kinetic pulverizer 50′ according to another implementation is shown. The kinetic pulverizer 50′ includes an inlet 70′ for receiving the feedstock 10 and an outlet 72′ for discharging the pulverized output stream 18. The kinetic pulverizer 50′ includes a rotatable shaft 106′ with a plurality of rigid rotor arms 122′ extending radially therefrom that generate an airflow. The kinetic pulverizer includes airflow deflectors 200′ that direct or channel the airflow to generate vortices within the kinetic pulverizer 50′ to cause self-collisions to thereby size reduce the feedstock 10.

In some implementations, the inlet 70′ can be modified or adjusted to accommodate the size of the feedstock 10. For example, when the feedstock 10 is manufacturing waste with an elongated shape, such as flooring planks or other building materials, the inlet 70′ can include a hood 78′ to direct the feedstock 10 into the kinetic pulverizer 50′.

In some implementations, an infeed conveyor 80′ can be used to deliver the feedstock 10 to the kinetic pulverizer 50′. For example, the infeed conveyor 80′ can deliver the manufacturing waste directly from the manufacturing stage 13 where the reject material is generated to the kinetic pulverization stage 16. The infeed conveyor 80′ can be modified or adjusted to accommodate the size of the feedstock 10. For example, when the manufacturing waste is an elongated material, such as flooring planks or other building materials, the infeed conveyor 80′ can have cleats 82′ that prevent the material from sliding or slipping due to gravity. In some implementations, the cleats 82′ are spaced apart by a pre-determined distance configured to fit the size of the reject material being input as the manufacturing waste feedstock 10. In the illustrated implementation, the cleats 82′ are spaced apart by about 152 cm (60 inches) to accommodate larger sizes of manufacturing waste, such as resilient flooring tile slabs that are 36 inches by 48 inches. However, it is understood that any configuration of the cleated infeed conveyor 80′ can be used to optimize the infeed operation to the specific type of feedstock 10 the kinetic pulverizer 50′ is being used with.

In some implementations, the infeed conveyor 80′ includes a nose 84′ (i.e., a nose over conveyor) to aid in the material pointing downwards prior to entering the kinetic pulverizer 50′.

In the illustrated implementation, the outlet 72′ is located at a bottom side of the kinetic pulverizer 50′, such that the pulverized output stream 18 is discharged axially below the rotatable shaft 106′. In some implementations, an outlet conveyor 86′ can be positioned below or operatively coupled to the outlet 72′. The outlet conveyor 86′ can be configured to transfer the pulverized output material 18 to the screening stage 20, for example to a mechanical screen or a magnetic separator, or directly back into the manufacturing stage 13. Similarly, additional conveyors can be provided from a screened side of the screening stage to transfer the size-reduced stream 22 directly back into the manufacturing stage 13.

### Metal Separation Stage

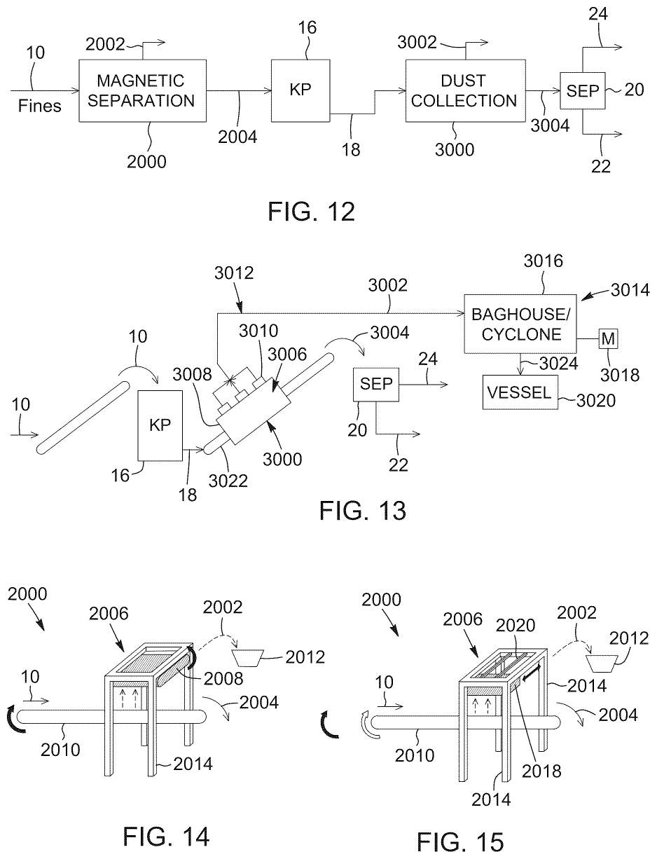

Referring now to FIG. 12, in some implementations the process includes a metal or magnetic separation stage 2000 upstream of the kinetic pulverization stage 16 to capture metal from the feedstock 10. The separated metal 2002 can be supplied as scrap metal for resale, recycled, re-introduced into the manufacturing stage 13, or disposed of. In some implementations, the magnetic separation stage 2000 can include magnets to separate ferrous metals from the feedstock 10 and/or a non-ferrous metal separator to separate non-ferrous metals with permanent magnets.

The metal depleted feedstock 2004 can be fed to the kinetic pulverization stage 16. The magnetic separator can be designed and operated to remove metal with a high weight density to reduce wear and damage on the kinetic pulverizer. For example, the magnetic separator can be provided based on nominal size of the feedstock and ferrous objects that would be desirable for removal. For instance, the magnetic separator can be provided to ensure removal of solid ferrous objects that have a high weight in an overall low volume. While some geometries, such as flat sheets, may pose little concern to the operation of the kinetic pulverizer 50, other geometries such as blocks, chunks, and the like can increase wear and damage and thus the magnetic separation stage 2000 facilitates removal to enhance downstream processing. The magnetic separator can be configured based on size of the feedstock, ferrous object size, and material burden depth. The magnetic separator could be actively controlled or simply turned on to enable the separation. The magnetic separation stage 2000 facilitates reduced risk of wear and damage to the kinetic pulverization stage 16, and also recovers scrap metal material.

In some implementations, the magnetic separation stage 2000 can be downstream of the kinetic pulverization stage 16 to remove the infrangible material from the pulverized output stream 18, the size-reduced stream 22, and/or the oversized stream 24. For example, small fragments of metal that cannot be separated from the size-reduced fraction with mechanical screening can be removed with a downstream magnetic separation stage 2000. When the feedstock 10 includes infrangible materials that are embedded in frangible materials, the infrangible metal material can be removed with a downstream magnetic separation stage 2000. When the oversized stream 24 includes both ductile materials and infrangible materials, the infrangible material can be separated from the ductile material with a downstream magnetic separation stage 2000. In some implementations, the process can include upstream and downstream magnetic separation stages 2000.

The magnetic separation stage 2000 can use various types of magnetic separators which can be selected based on the feedstock and throughput. For example, the magnetic separator can be a dry-type magnetic separator or wet type magnetic separator depending on the moisture content of the feedstock. The magnetic separator can have a magnetic field strength that is designed for removal of target ferrous metal objects that could be problematic for the kinetic pulverization stage 16. The magnetic separator could also include a permanent magnet and electromagnetic magnetic separator. The magnetic separator can also have various design and structural features, e.g., drum type, roller type, disc type, ring type, belt type, among others. The magnetic separator can also use constant, alternating, pulsating, or rotating magnetic fields depending on the design and configuration of the system and the feedstock. The magnet itself can be composed of various materials.

While magnetic separation is a preferred mechanism to remove metals from the feedstock, there are various other metal removal methods that could be used instead of or in addition to magnetic separation. An additional metal removal stage could be designed to remove non-ferrous metals, for example, particularly metal debris that has a high weight density and are thus relatively heavy and thick. In some implementations, the metal removal method (e.g., magnetic separation) is performed to remove all metal debris having an average diameter of 1 inch or greater. Metal debris that is lump shaped or elongated is removed, while metal debris that has a flat sheet shape is optionally removed.

Referring now to FIGS. 13 and 14, two example configurations are shows for the magnetic separation stage 2000. FIG. 13 shows a belt magnetic separator 2006 including a self-cleaning magnetic belt 2008 that is above a conveyor 2010. The magnetic belt 2008 discharges the ferrous metals into a bin 2012. The magnetic belt 2008 can be mounted to a magnet frame 2014 that spans across the conveyor 2010, such as an infeed conveyor and/or an outfeed conveyor. FIG. 14 shows an alternative configuration including a stationary magnet 2018 on rails 2020 mounted above the conveyor 2010 and configured to move back and forth.

### Dust Collection Stage

Referring back to FIG. 12, the process can also include a downstream dust collection stage 3000 for recovering dust that is part of the pulverized output stream 18 exiting the kinetic pulverization stage 16. The pulverized output stream 18 enters the dust control stage 3000, which recovers a dust stream 3002 and produces a dust reduced pulverized stream 3004 that is fed to the separation stage 20. The dust collection stage 3000 facilitates dust control and can include various units, such as a settling chamber and a baghouse or cyclone filtration unit.

Referring to FIG. 13, the dust collection stage 3000 can include a dust collector 3006 that is coupled to the exit of the kinetic pulverization stage 16 and may include a settling chamber 3008 that has dust outlets 3010 positioned on its top. The dust outlets can be in fluid communication via ducting 3012 to a dust recovery unit 3014 that includes a baghouse or cyclone filtration unit 3016 having a dedicated motor 3018. The dust recovery unit 3014 can also include a dust recovery vessel 3020 that receives the dust from the baghouse or cyclone filtration unit, for example via a hopper.

The settling chamber 3008 can receive all of the output from the kinetic pulverization stage 16 and thus receives relatively fine particles that are deposited on an outfeed conveyor 3022 so that the fines are added to the diverted output. Fine particles settle on the outfeed conveyor 3022, while very fine dust particles are accumulated and withdrawn from the settling via the dust outlets 3010. The settling chamber 3008 can extend over a part or the entire length of the outfeed conveyor 3022 depending on the process design and the target level of dust control. The settling chamber 3008 can be in communication with the outlet of the kinetic pulverizer via a flexible tubular member as the kinetic pulverizer can experience vibration.

The quantity of dust in the pulverized output stream 18 is highly dependent upon the type and dryness of the feedstock supplied to the kinetic pulverization stage 16. For instance, output diversion rates as high as about 30% have been observed for some feedstocks. In some implementations, the feedstock 10 can undergo a surface wetting pretreatment step to increase the moisture content and help reduce the amount of dust being produced. After the moisture content of the feedstock 10 has been increased, the pulverizing stage reduces the moisture, therefore requiring an addition dust collecting stage 3000.

It is noted that the power and suction of the dust collection stage 3000 can be adjusted to increase the amount of material capture in the dust collector. For example, the dust recovery unit 3014 can be controlled to provide a desired suction in the dust collector 3006. Therefore, the dust collection stage 3000 can be designed and operated to be a tool in the separation of the outbound material from the kinetic pulverization stage 16, such as separating small and low-density frangible material from larger or more dense frangible materials. In some implementations, when processing manufacturing reject material from a resilient flooring manufacturing process, it may be preferable to isolate a very fine powder (dust) via the dust collection stage 3000 and use the dust stream 3002 for certain layers of the manufacturing process. Similarly, when processing shingles waste, it may be preferable to isolate a smaller powder (<595 to 250 microns or less than 250 microns in size), a portion of which can be collected via the dust collection stage 3000 and use the dust stream 3002 for the asphalt layer in a subsequent shingles manufacturing process or as an isolated, purified asphalt or asphaltic limestone stream. Alternatively, it may be preferable to isolate the small particles that may include asphaltic limestone from the purified asphaltic granules. In such implementations, the dust collection stage (or separation stages) can be used to remove the asphaltic limestone from the purified asphalt granules. It is also noted that the dust collector 3006 can also pick up some ductile materials, such as paper or plastic film pieces, which are relatively light, and such ductile materials can therefore be separated by both or either of the separate stage 20 and the dust collection stage 3000.

Still referring to FIG. 13, the baghouse filtration or cyclone filtration 3016 traps finer and lighter material, which can be stored in the vessel 3020. This fine recovered material 3024 can be added back into the diverted output stream, disposed of and/or kept as a fines product for sale. The fine recovered material 3024 can be recycled back into one or more stages of the system. In some implementations, the fine recovered material 3024 would be supplied into the dust reduced stream 3004 or the size-reduced stream 22, or would be kept as a distinct product stream that could be sold or mixed with other materials to provide a commercial product. It is noted that the recovered dust material can be treated, transported, and used in various ways, some of which are described herein.

### Example Implementations

### Luxury Vinyl Tile Flooring as a Feedstock

In some implementations, the kinetic pulverization stage 16 can be used in conjunction with the manufacturing of luxury vinyl tile (LVT) flooring. During the manufacturing stage 13, layers comprising PVC, filler, and pigments are pressed together with heat to form a wear layer, a core layer, a bottom layer, and a decorative layer. When layers are improperly formed or the flooring is damaged in some other way, the LVT floor can be separated into a reject material stream. When pulverized to a small enough particle size, the pulverized PVC and filler forming the rejected LVT floor can be used as a portion of the filler used in a subsequent manufacturing stage (i.e., to form new LVT flooring). In some implementations, up to 20% of the pulverized LVT reject material can be included in a subsequent manufacturing process as filler. In some implementations, the filler has a particle size of less than about 1600 μm.

The manufactured LVT products can be pre-sorted to separate the reject materials (mis-shaped or broken tiles, etc.) from the usable or sellable manufactured product. The sorted reject materials (manufacturing waste) can then, automatically or manually, be subjected to the kinetic pulverization stage 16 to size reduce and produce a pulverized output stream 18.

In some implementations, the kinetic pulverizer 50 can be operated such that a majority of the manufacturing waste is size reduced in a single pass. For example, the kinetic pulverizer can be operated with a rotor shaft speed of 750 rpm to 1025 rpm. In some implementations, the rotor speed of the kinetic pulverizer 50 is optimized to provide a pulverized output stream with at least 80%, at least 90%, at least 95%, or at least 99% of the manufacturing waste being sized reduce to at least 2000 μm in a single pass. In some implementations, an entirety (100%) of the manufacturing waste is size reduced to at least 1600 μm in a single pass (one pass). In some implementations, the kinetic pulverizer can be operated at 975 rpm to pulverize the LVT rejection material such that 100% of the pulverized output stream 18 has a particle size of less than 1600 μm (i.e., passes through a 1600 μm screen).

In some implementations, once the kinetic pulverizer has been optimized to pulverize 100% of the manufacturing waste, the pulverized output stream 18 can be redirected, manually or automatically, back into the manufacturing stage, without subjecting the pulverized output stream 18 to a separation stage 20. Alternatively, the pulverized output stream 18 can then be subjected to a separation stage 20 to ensure that all the material being introduced back into the manufacturing stage 13 has a sufficiently small particle size. If less than 100% of the feedstock is pulverized, an oversized fraction can be separated from the pulverized fraction to produce a size reduced stream 22 and an oversized stream 24. In such implementations, the oversized stream 24 can automatically or manually be subjected to the kinetic pulverization stage again and the size reduced stream 22 can be redirected, manually or automatically, back into the manufacturing stage.

In some implementations, the kinetic pulverizer 50 can be operated such that a ductile material embedded in the manufacturing waste can be liberated from a frangible material. In some implementations, the LVT flooring panels include a rigid core that comprises filler and PVC, which is frangible, and a decorative layer covered with a thin wear layer of PVC. When operated at a sufficiently high speed, such as over 925 rpm, the decorative layer and/or wear layers can be sized reduced to less than 1600 μm. However, the kinetic pulverizer 50 can be operated such that an entirety of the rigid core is size reduced, but the decorative layer and wear layer are only partially size reduced. For example, the kinetic pulverizer 50 can be operated with a rotor shaft speed of 800 rpm to 900 rpm to size reduce the core layer while only partially size reducing a fraction of the decorative layer and wear layer. In other words, when LVT flooring panels are subjected to the kinetic pulverization stage 16 with the kinetic pulverizer 50 operated at 800 rpm to 900 rpm, the pulverized output stream 18 comprises a ductile fraction that includes the decorative layer and the wear layer and a frangible fraction that includes the core layer. The pulverized output stream 18 can then be subjected to the separation stage 20 to separate the ductile (oversized) fraction from the frangible fraction to produce a size reduced stream 22 and an oversized stream 24. In other words, a portion of the decorative layer and the wear layer can be removed from the pulverized core layer. In some implementations, removing the decorative layer and wear layer can increase the quality of the size reduced fraction that is re-introduced into the manufacturing process. The size reduced stream 22 can then be redirected to the manufacturing stage 13.

In some implementations, the pulverized output material 18 can be subjected to a dust collection stage, where a fraction of dust is selectively removed from the pulverized output material 18. In the context of LVT flooring panels, the dust collected in the dust collection stage is a fine powder, which can be individually redirected into the manufacturing stage 13, re-added to the pulverized output material 18 or the size reduced stream 22 prior to being added to the manufacturing stage, or re-cycled for another purpose.

### Stone Polymer Composite Flooring as a Feedstock

In some implementations, the kinetic pulverization stage 16 can be used in conjunction with the manufacturing of stone polymer composite (SPC) flooring, which can also be referred to as solid polymer composite flooring. SPC flooring can be formed of a dense layer of filler and PVC and an outer wear layer of PVC. In some implementations, up to 20% of the filler used in the manufacturing stage 13 can be pulverized SPC flooring that was categorized as reject material.

The SPC waste recycling process is similar to the process of recycling LVT waste. The reject material from the manufacturing stage 13 that produces the SPC flooring is selectively subjected to the kinetic pulverization stage 16 to size reduce the manufacturing waste. For example, the kinetic pulverizer 50 can be operated such that a majority of the SPC flooring is size reduced in a single pass when operated with a rotor shaft speed of 925 rpm to 1025 rpm, or in some implementations, 975 rpm. In some implementations, the rotor speed of the kinetic pulverizer 50 can be optimized to provide a pulverized output stream 18 with at least 60%, at least 70%, at least 75%, at least 80%, at least 85%, or at least 90% of the manufacturing waste being size reduced to at least 750 μm in a single pass. In some implementations, about 80% of the manufacturing waste is size reduced to at least 500 μm in a single pass (one pass). In some implementations, the kinetic pulverizer can be operated at 975 rpm to pulverize the SPC rejection material such that 80% of the pulverized output stream 18 has a particle size of less than 500 μm (i.e., passes through a 500 μm screen after a single pass through the kinetic pulverizer). The oversized fraction can be separated from the pulverized fraction in the separation stage 20 to produce a size reduced stream 22 and an oversized stream 24. In such implementations, the oversized stream 24 can automatically or manually be subjected to the kinetic pulverization stage again.

In some implementations, the kinetic pulverizer 50 can be operated such that a portion of the oversized PVC wear layer of the SPC flooring can be selectively separated from the frangible core, for example with a rotary speed of about 800 rpm to 900 rpm. The pulverized output stream 18 can then be subjected to the separation stage 20 to separate the ductile (oversized) fraction from the frangible fraction to produce a size reduced stream 22 and an oversized stream 24. The size reduced stream 22 can then be redirected to the manufacturing stage 13.

In some implementations, the pulverized output material 18 can be subjected to a dust collection stage, where a fraction of dust is selectively removed from the pulverized output material 18. In the context of SPC flooring panels, the dust collected in the dust collection stage is a fine powder, which can be individually redirected into the manufacturing stage 13, re-added to the pulverized output material 18 or the size reduced stream 22 prior to being added to the manufacturing stage, or re-cycled for another purpose.

### Asphalt Shingles as the Feedstock

In some implementations, the kinetic pulverization stage 16 can be used in conjunction with the manufacturing of asphalt shingles. Asphalt shingles can be formed of a ductile underlayer coupled to a frangible asphalt and mineral granule overlayer, such that the pulverization stage allows liberation and recovery of the asphalt and mineral granule from the ductile underlayer film or membrane. The ductile underlayer includes a chemical sealant that softens under solar heat to seal the shingles to the roof surface. The asphalt shingles can be sorted or unsorted and sized or unsized shingles that are between ¼ of an inch to full-sized, such as 12 inches by 36 inches. In some implementations, the asphalt shingles can be used shingles removed during demolition or a roofing operation that include a fiberglass or paper underlayer film that is coupled to an asphalt overlayer, and optionally can include used metal fasteners, such as roofing nails, that are embedded in the shingle. In some implementations, the single stream feedstock can include factory rejects, such as malformed shingles, that do not include used fasteners.

In some implementations, asphalt shingles contain about 19% to 36% asphalt cement, about 8% to 40% of mineral filler stabilizers (for example, limestone, silica, or dolomite), and about 20% to 38% mineral granules that are coupled to a felt mat underlayer, which typically consists of a paper or fiberglass mat. In some implementations, the asphalt shingles include a chemical sealant that is activated by low levels of heat (such as solar warmth on a roof).

The asphalt shingles recycling process can optionally include obtaining reject shingle material from the manufacturing stage 13 that produces the asphalt shingles or obtained or isolated from post-consumer waste, such as a general waste stream or construction and demolition debris stream. In some implementations, the asphalt shingle waste stream can be subjected to a size-reduction pre-treatment stage to produce a size-reduced feedstock, for example having a size of less than ⅜ of an inch. The asphalt shingles waste and/or the size-reduced feedstock can be selectively subjected to the kinetic pulverization stage 16 to pulverize the frangible asphalt while allowing the ductile underlayer to remain substantially non-size reduced. Specifically, the kinetic pulverizer pulverizes and homogenizes the more frangible asphalt component and liberates the asphalt component from the less frangible mineral granules and ductile plastic or fibrous underlayer.

When the feedstock 10 includes shingles, the feedstock 10 can further include an infrangible material that is not significantly size-reduced (such as metal fasteners), and can be separated from the material during a downstream separation stage. In some embodiments, certain sized fractions of the pulverized output stream 18 comprising the frangible component and/or the ductile component can be recirculated through a second kinetic pulverization stage 16. The second kinetic pulverization stage 16 can be a second kinetic pulverizer 50, or the pulverized output stream 18 can be recirculated through the same kinetic pulverizer 50.

As described herein, the kinetic pulverizer causes matter-on-matter collisions within the vortexes created by the kinetic pulverizer. Asphalt shingles generally contain about 19% to 36% asphalt cement, which can form a sticky, black, highly viscous liquid or semi-solid form when subjected to heat. Conventional methods of grinding asphalt shingles generate heat and can cause the asphalt and/or chemical sealant to form a sticky, viscous semi-solid and impair the functioning of the grinder and/or the quality of the final end product. However, when asphalt shingles are subjected to the kinetic pulverization stage, the shingles are subjected to matter-on-matter collisions within vortexes that inherently have an airflow that reduces heat that is produced from the matter-on-matter collisions. In some embodiments, the kinetic pulverization stage 16 is around 15 to 20 seconds for any given material, before the material is expelled via a lower outlet, thus resulting in significantly less heat production. The resulting pulverized output stream 18 includes a pulverized frangible material (i.e., an unheated or cooled asphalt product that is micronized or nanosized and homogenized) that is liberated from an oversized ductile material (i.e., the paper or fiberglass underlayer), and optionally, when the feedstock 10 includes used asphalt shingles, an infrangible material (i.e., the metal fasteners or other impurities).

In some embodiments, the kinetic pulverization stage 16 can be used in processes for separating and extracting raw materials from residential roofing products, such as asphalt shingles, such as the processes described in U.S. Pat. Nos. 8,919,681, 9,156,035, and 9,440,239, all of which are incorporated herein by reference. In some embodiments, the kinetic pulverizer 50 as described herein could replace one or more of the size reduction stages in these processes. For example, the kinetic pulverization stage 16 described herein can be used to mechanically reduce the size of the residential roofing products to produce shredded and/or chip products, while leaving the ductile underlayer as an oversized fraction.

In some implementations, the kinetic pulverizer 50 is operated such that a majority of the asphalt and mineral overlayer is size reduced in a single pass to below about 2380 microns, below about 595 microns, or below about 250 microns. In some implementations, the rotor speed of the kinetic pulverizer 50 can be optimized to provide a pulverized output stream 18 with at least 60%, at least 70%, at least 75%, at least 80%, at least 85%, or at least 90% of the shingles waste stream being size reduced to 2380 microns or less, or 595 microns or less, in a single pass. In some implementations, about 80% of the shingles waste stream is size reduced to below about 2380 microns, below about 595 microns, or below about 250 microns in a single pass (one pass).

During the separation stage 20, the oversized fraction derived from the shingle underlayer can be separated from the pulverized fraction derived from the asphalt and mineral overlayer to produce a size reduced stream 22 and an oversized stream 24. In some implementations, the oversized stream 24 can automatically or manually be subjected to the kinetic pulverization stage again to remove any additional frangible material from the ductile underlayer.

In some implementations, the separation stage 20 can include one or more subsequent separation stages that further separate different components of the size reduced stream 22 and/or the oversized stream 24. For example, after the ductile underlayer and the frangible overlayer have been separated out into the oversized stream 24 and the undersized stream 22, respectively, the undersized stream 22 can undergo an additional separation stage 20 to separate the granular asphalt from the powdered asphaltic limestone to produce purified or partially purified asphalt stream and an asphaltic limestone stream. By processing the asphalt shingles in a dry process (as opposed to adding moisture to control heat and melting of the asphalt), the pulverized output stream 18 resulting from the kinetic pulverization stage 16 can efficiently turn the asphalt into clean granular asphalt with minimal contamination from other minerals, such as limestone, which can then be manually or automatically used in a subsequent shingles manufacturing process. In some implementations, the separated granular asphalt component is directly included in the manufacturing process to avoid the chemical sealant from causing agglutination in the asphalt shingles post-treatment (i.e., after the kinetic pulverization stage). In some implementations, the separation stage 20, which can include known chemical separation techniques, density separation, size-based separation, etc., is conducted immediately after the kinetic pulverization stage (for example, along a conveyor line that is inline with the outlet of the kinetic pulverizer).

In some implementations, the pulverized output stream 18 and/or the undersized stream 22 containing asphalt granules can be subjected to a density base separation stage 20 to separate the asphalt component from the other minerals. The purified streams can then be used in a manufacturing process for shingles or other types of products, to produce oil products, build roads, etc.

In some implementations, the kinetic pulverizer 50 can be operated such that a portion of the asphalt component is pulverized into a powder size (for example, between 595 microns and 250 microns or less than 250 microns), which can include high concentrations (such as over 60%, over 70%, over 80%, over 90%, over 95% or even over 99%) of purified asphalt or asphaltic limestone that can be used as conventional asphalt, such as to produce oil products, roads, etc., or used as a filler. A remaining portion of the asphalt is granular sized (for example, between about 2380 microns and about 595 microns, or about 1000 microns to 595 microns, or between about 595 microns and 250 microns), which can be purified asphalt (clean granules) and can be used to produce new asphalt shingles. In some implementations, the kinetic pulverizer is operated with a rotary speed of 850 rpm, 800 rpm, 750 rpm, 700 rpm, 650 rpm or less. In some implementations, the kinetic pulverizer can be operated at more than about 850 rpm, more than 900 rpm, more than 950 rpm or higher to size reduce the asphalt granules and the powdered asphalt.

In some implementations, the shingles waste feedstock is subjected to a size-reduction pre-treatment (upstream) stage to reduce the feedstock to about ⅜ inches or less. The size-reduced feedstock can optionally be subjected to an upstream magnetic separation stage before being subjected to a kinetic pulverization stage 16 to produce the pulverized output stream 18. The pulverized output stream 18 is subjected to a separation stage 20 using mechanical screens to produce an undersized stream 22 that includes asphalt granules and other minerals, such as limestone, sand, etc., and an oversized stream 24 that includes the fiberglass, organic, or other type of backing material.

In some implementations, one or more secondary separation stages using dust collection can be conducted on the undersized stream 22, for example, to isolate a purified stream of powered asphalt or asphaltic limestone. In some implementations, the undersized stream 22 is subjected to one or more secondary screening stages, either density or size based, to isolate the asphalt component, for example as an oversized stream, from the other minerals present in the overlayer of the shingles.

The undersized stream 22 of the first separation stage and/or the oversized stream of a second separation stage can be immediately directed to a manufacturing stage for producing asphalt shingles. In some implementations, sand is mixed with the undersized stream 22 of the first separation stage and/or the oversized stream of a second separation stage to prevent agglutination post-kinetic pulverization.

### EXPERIMENTATION

### Example 1—LVT Flooring Slabs

After the manufacturing stage, rejected LVT flooring slabs that were approximately 36 inches by 48 inches, were separated from the properly formed LVT flooring slabs as reject material. The rejected LVT flooring slabs were fed into a kinetic pulverizer via a cleated conveyor belt. The kinetic pulverizer was operated with a shaft speed of 975 rpm. The pulverized output stream was subjected to a dust collection stage at the outlet to produce a dust fraction and a dust-depleted pulverized output stream. The dust-depleted pulverized output stream was subjected to a separation stage with a 1600 μm mechanical screen. After one pass through the kinetic pulverizer (a “one pass kinetic pulverization stage”), 100% of the dust-depleted pulverized output stream passed through the 1600 μm screen. The screened dust-depleted pulverized output stream, having a particle size of less than 1600 μm, was then reintroduced into the manufacturing stage as a filler for subsequently produced LVT flooring tiles, planks, or slabs. In other words, 100% of the reject LVT flooring slabs were pulverized and reintroduced into the manufacturing process for subsequence LVT flooring components.

### Example 2—LVT Flooring Slabs

After the manufacturing stage, rejected LVT flooring slabs that were approximately 36 inches by 48 inches, were separated from the properly formed LVT slabs as reject material. The rejected LVT flooring slabs were fed into a kinetic pulverizer via a cleated conveyor belt. The kinetic pulverizer was operated with a shaft speed of 900 rpm. A pulverized output stream was collected from the outlet of the kinetic pulverizer and screened with a 1600 μm screen to selectively isolate a portion of the decorative and wear layers.

### Example 3—SPC Flooring Slabs

After the manufacturing stage, rejected SPC flooring slabs that were approximately 36 inches by 48 inches, were separated from the properly formed SPC flooring slabs as reject material. The rejected SPC flooring slabs were fed into a kinetic pulverizer via a cleated conveyor belt. The kinetic pulverizer was operated with a shaft speed of 975 rpm. Referring now to FIG. 16, the pulverized output stream was subjected to a dust collection stage at the outlet to produce a dust fraction 402 and a dust-depleted pulverized output stream 404. The dust-depleted pulverized output stream 404 was subjected to a separation stage with a 500 μm mechanical screen. After one pass through the kinetic pulverizer (a “one pass kinetic pulverization stage”), 80% of the dust-depleted pulverized output stream 404 passed through the 500 μm screen. The screened dust-depleted pulverized output stream 404, having a particle size of less than 500 μm, was then reintroduced into the manufacturing stage as a filler for subsequently produced SPC flooring tiles.

### Example 4—SPC Flooring Slabs

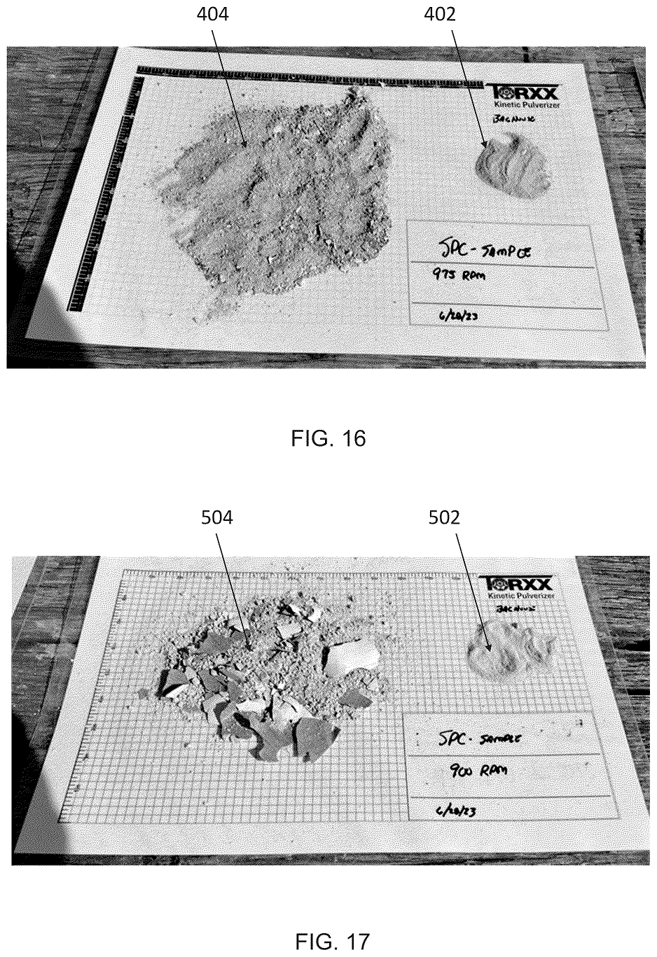

After the manufacturing stage, rejected SPC flooring slabs that were approximately 36 inches by 48 inches, were separated from the properly formed SPC slabs as reject material. The rejected SPC flooring slabs were fed into a kinetic pulverizer via a cleated conveyor belt. The kinetic pulverizer was operated with a shaft speed of 900 rpm. Referring now to FIG. 17, the pulverized output stream was subjected to a dust collection stage at the outlet to produce a dust fraction 502 and a dust-depleted pulverized output stream 504. As can be seen, the dust-depleted pulverized output stream 504 includes portions of the decorative layer and the wear layer that were not size reduced to below 500 μm. The pulverized output stream can be subjected to a separation stage by screening with a 500 μm screen to produce a size reduced stream that is suitable for reintegration into the manufacturing stage as fill and an oversized stream that includes the decorative and wear layers.

### Example 5—Asphalt Shingles

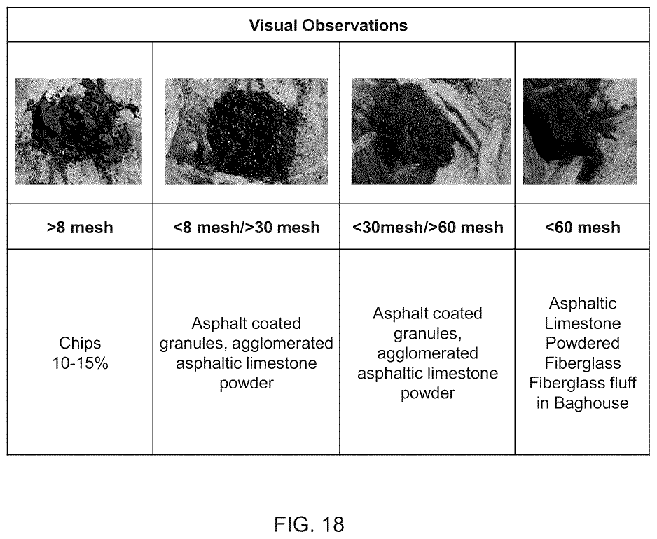

Three types of asphalt shingles were subjected to a kinetic pulverization stage using the kinetic pulverizer described herein. Sample 1 included DYNASTY™ full sized shingles, sample 2 included Lincoln Young™ shingles that were ground up and processed with a ROTO-CHOPPER™ to a particle size of less than ⅜ of an inch, and sample 3 included IKO HY™ factory rejects having a size of less than 4 inches that were partially size reduced with a 3E shredder and Schutte-Buffalo™ hammermill having 32 inch hammers and 2 inch spaced grates. The three samples were subjected to the kinetic pulverization stage at 850 rpm and/or 950 rpms and the resultant pulverized output was subjected to multiple separation stages using 8 (2380 microns), 20 (841 microns), 30 (595 microns), 40 (400 microns), 50 (297 microns), 60 (250 microns), 80 (177 microns), 100 (149 microns), and 200 (74 microns) mesh sized screens to determine the size where clean asphalt particles become contaminated with asphaltic limestone powder. The resultant pulverized material was visually inspected with the results shown in FIGS. 18 to 20. A dust collection stage was also conducted after the kinetic pulverization stage. In all samples, 100% of the dust fraction isolated from the dust collection stage pass through a 60 mesh screen (i.e., are less than 250 microns in size).

Referring now to FIG. 18, sample 1 was subjected to a kinetic pulverization stage at 850 rpm. As can be seen, when the shingles did not undergo a size reduction pre-treatment stage, the material passing through a 60 mesh screen (250 microns or less) included asphaltic limestone and powdered fiberglass. The dust fraction isolated from the dust collection stage also included portions of the fiberglass backing.

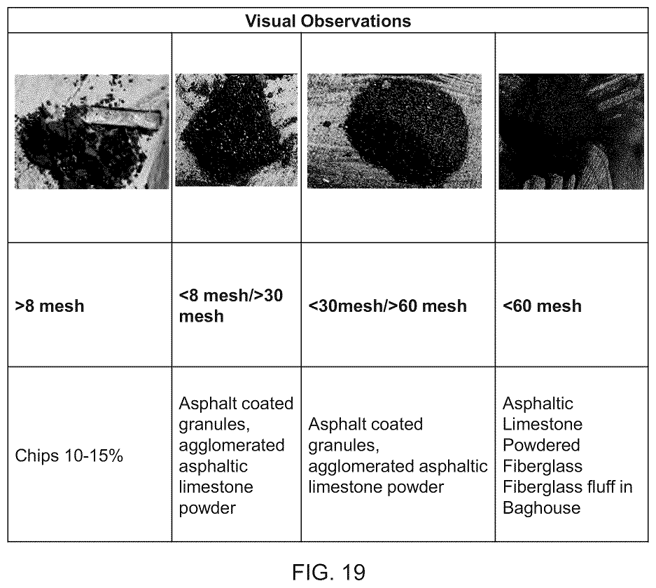

Referring now to FIG. 19, sample 1 was subjected to a kinetic pulverization stage at 950 rpm. As can be seen, when the shingles did not undergo a size reduction pre-treatment stage, the samples that did not pass through an 8 mesh screen (greater than 2380 microns) included larger pieces of the ductile backing material (fiberglass). The material passing through a 60 mesh screen (250 microns or less) included asphaltic limestone and powdered fiberglass. The dust fraction isolated from the dust collection stage also included portions of the fiberglass backing.

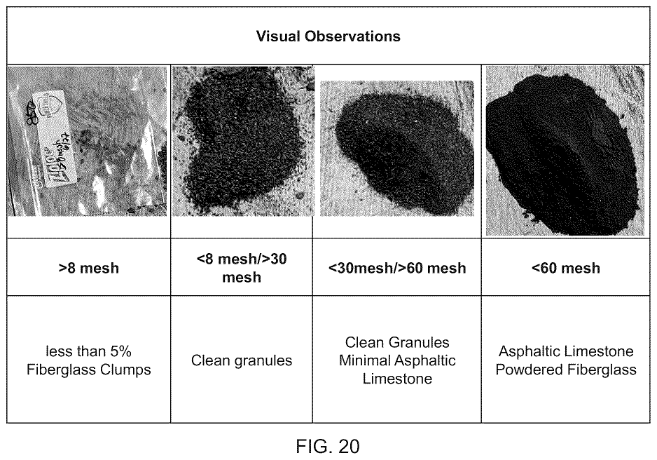

Referring now to FIG. 20, sample 2 was subjected to a kinetic pulverization stage at 850 rpm. As can be seen, when the shingles did undergo a size reduction pre-treatment stage, the material passing through a 60 mesh screen (250 microns or less) also included asphaltic limestone and powdered fiberglass; however, the material passing through an 8 mesh screen but not passing through a 30 mesh screen (i.e., having a particle size of between 2380 microns and 595 microns) and the material passing through a 30 mesh screen but not passing through a 60 mesh screen (i.e., having a particle size of between 595 microns and 250 microns) appear to have clear asphalt granules with minimal contamination by limestone. As such, it was observed that the kinetic pulverization stage produced a higher concentration of purified asphalt granules when the feedstock was subjected to a size-reduction pre-treatment stage (to less than ⅜ of an inch) prior to the kinetic pulverization stage.

### Example 6—Wind Turbine Blades

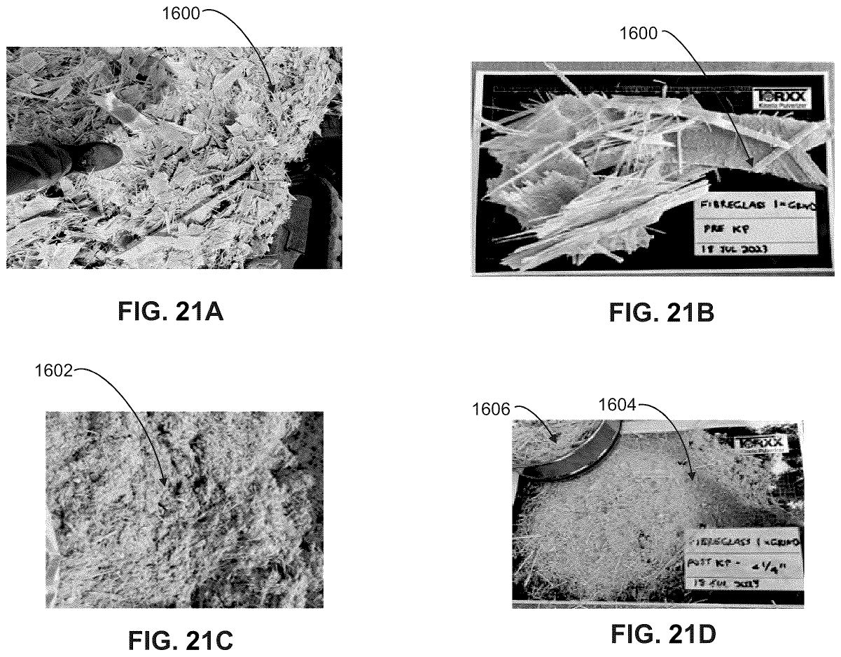

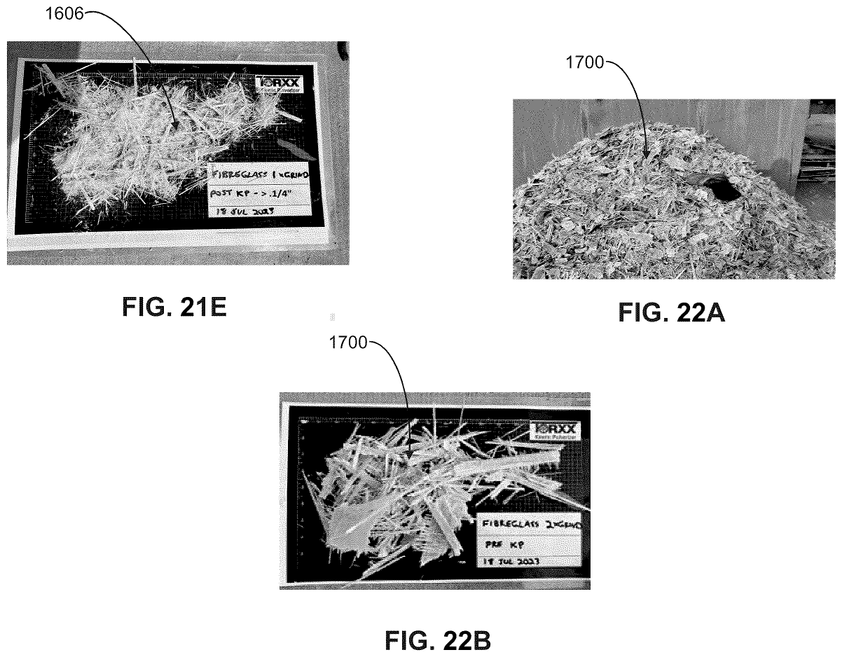

Referring now to FIGS. 21A to 23E, wind turbine blades comprising high-strength fiberglass were obtained at the end of their use life and processed to isolate the fiber component from the binder component.

With specific reference to FIGS. 21A to 21E, the wind turbine blades underwent one size-reduction pre-treatment stage using a grinder to produce 4,600 pounds of one-time pre-shredded feedstock 1600 (FIGS. 21A and 21B). The one-time pre-shredded feedstock 1600 had varying dimensions, as shown in FIG. 21B.

2,140 pounds (1.07 tons) of one-time pre-shredded feedstock 1600 was subjected to a kinetic pulverization stage at 950 RPM over a run time of 6 minutes and 54 seconds to produce a pulverized output stream 1602. The total throughput was 9.3 tons per hour (tph). The pulverized output stream 1602 from the first kinetic pulverization stage (FIG. 21C) was subjected to a dust collection stage to produce a dust fraction. The dust-depleted stream was subjected to a separation stage using a ¼ inch mechanical screen (FIGS. 21D and 21E) to produce an undersized stream 1604 of less than ¼ inch and an oversized stream 1606 of greater than ¼ inch.

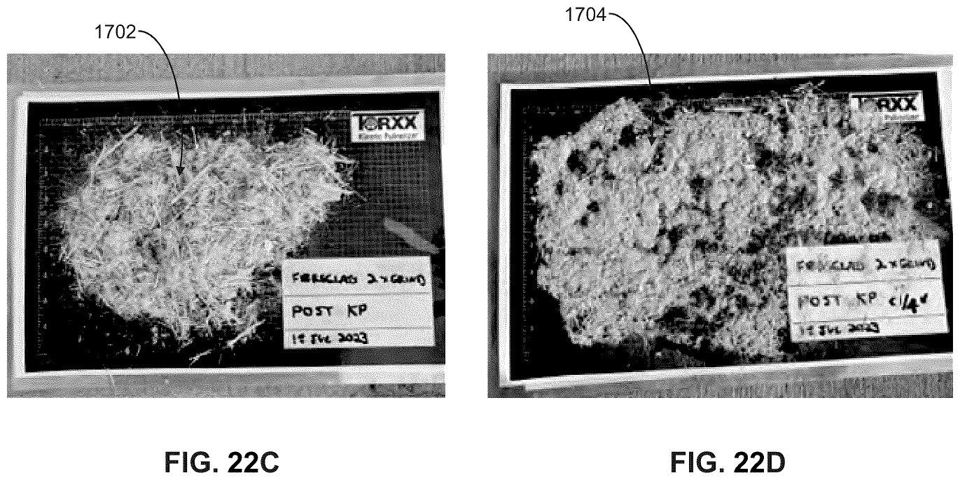

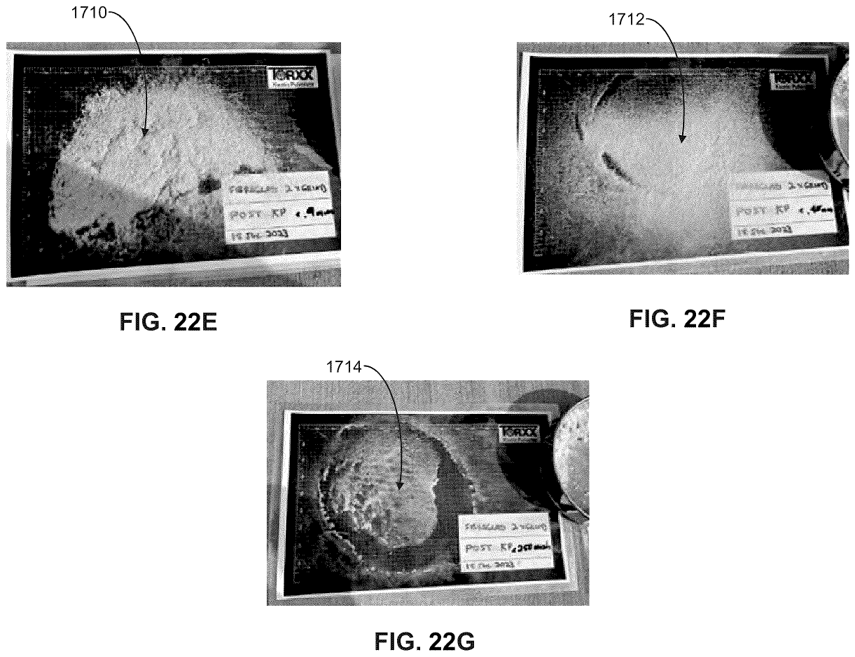

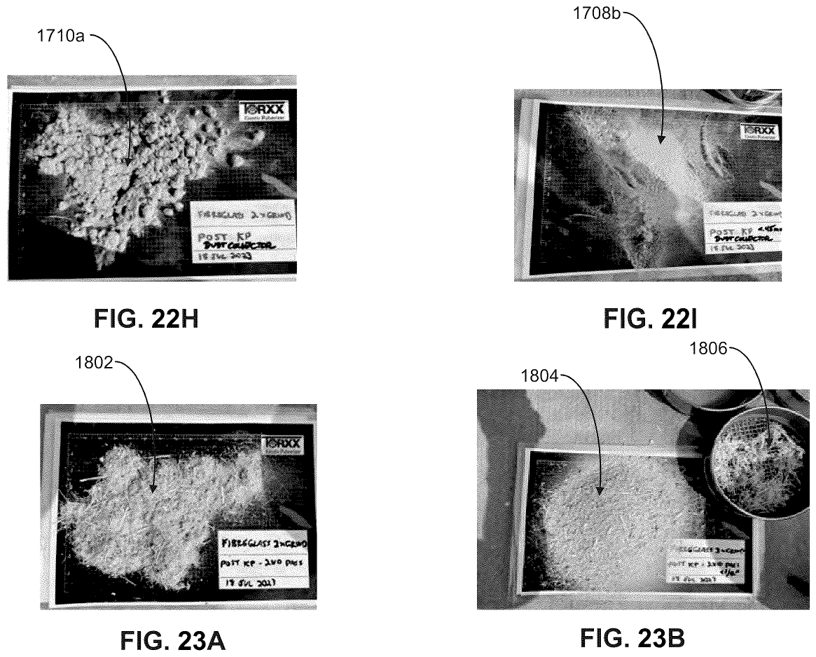

With specific reference to FIGS. 22A to 22I, 2,460 pounds (1.23 tons) of the one-time pre-shredded feedstock 1600 was subjected to a second size-reduction pre-treatment stage using a grinder to produce a twice pre-shredded feedstock 1700 (FIGS. 22A and 22B). The twice pre-shredded feedstock 1700 was subjected to the kinetic pulverization stage at 950 RPM over a run time of 7 minutes and 4 seconds. The total throughput was 10.4 tons per hour (tph). The pulverized output stream 1702 (FIG. 22C) from the first kinetic pulverization stage was subjected to a dust collection stage to produce a dust fraction 1708a (FIG. 22H). The dust fraction 1708a was subjected to a separation stage using a 0.45 mm (0.018 inches) screen to produce a screened dust fraction 1708b.

The pulverized output stream 1702 (FIG. 22C) was subjected to a separation stage using a 6.35 mm (0.25 inch) mechanical screen to produce an undersized stream 1704 of less than 6.35 mm and an oversized stream (not shown). The undersized stream 1704 was further subjected to a second separation stage using a 0.9 mm (0.35 inches) mechanical screen to produce a second undersized stream 1710. The second undersized stream 1710 was subjected to a third separation stage using a 0.45 mm (0.018 inches) mechanical screen to produce a third undersized stream 1712. The third undersized stream 1712 was subjected to a fourth separation stage using a 250 mesh (0.061 mm or 0.0024 inches) mechanical screen to produce a fourth undersized stream 1714.

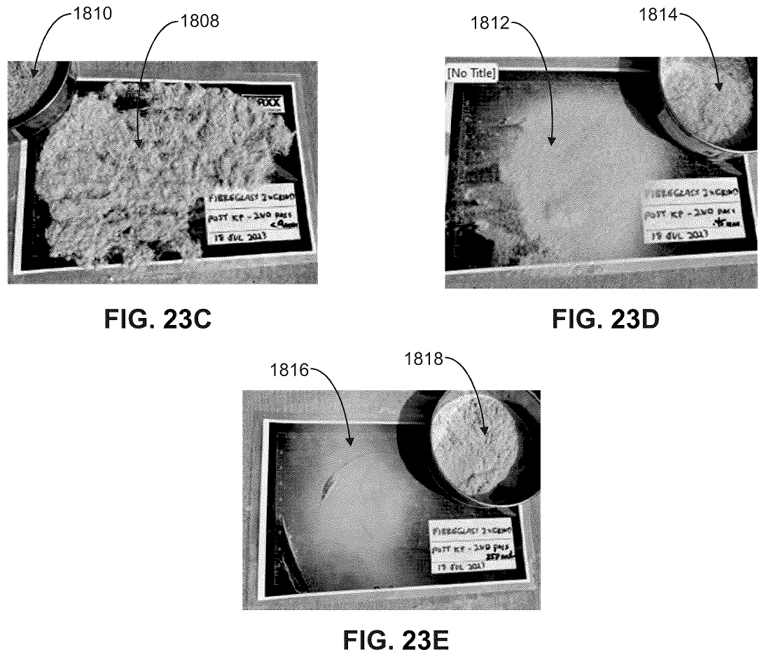

With specific reference to FIGS. 23A to 23E, ¼ of the pulverized output stream 1702 (FIG. 22C) from the first kinetic pulverization stage was subjected to a second kinetic pulverization stage at 950 RPM over a run time of 1 minute and 45 seconds. The pulverized output stream 1802 of the second kinetic pulverization stage was subjected to a second dust collection stage to produce a dust fraction. The second dust collection stage included a similar volume of dust fraction isolated from only ¼ of the feedstock being subjected to the second kinetic pulverization stage as the volume of dust fraction collected during the first dust collection stage. Accordingly, it was observed that the second kinetic pulverization stage produced about four times the dust fraction as the first kinetic pulverization stage.

The pulverized output stream 1802 was subjected to a separation stage using a 6.35 mm (0.25 inch) mechanical screen to produce an undersized stream 1804 of less than 6.35 mm and an oversized stream 1806. The undersized stream 1804 was further subjected to a second separation stage using a 0.9 mm (0.35 inches) mechanical screen to produce a second undersized stream 1808 and a second oversized stream 1810. The second undersized stream 1808 was subjected to a third separation stage using a 0.45 mm (0.018 inches) mechanical screen to produce a third undersized stream 1812 and a third oversized stream 1814. The third undersized stream 1812 was subjected to a fourth separation stage using a 250 mesh (0.061 mm or 0.0024 inches) mechanical screen to produce a fourth undersized stream 1816 and a fourth oversized stream 1818.

Based on visual observations, it is theorized that between 80% and 95% of the second undersized stream 1808 is the pulverized binder component and over 99% of the third undersized stream 1812 is the pulverized binder component.

### Example 7—Hardie™ Siding

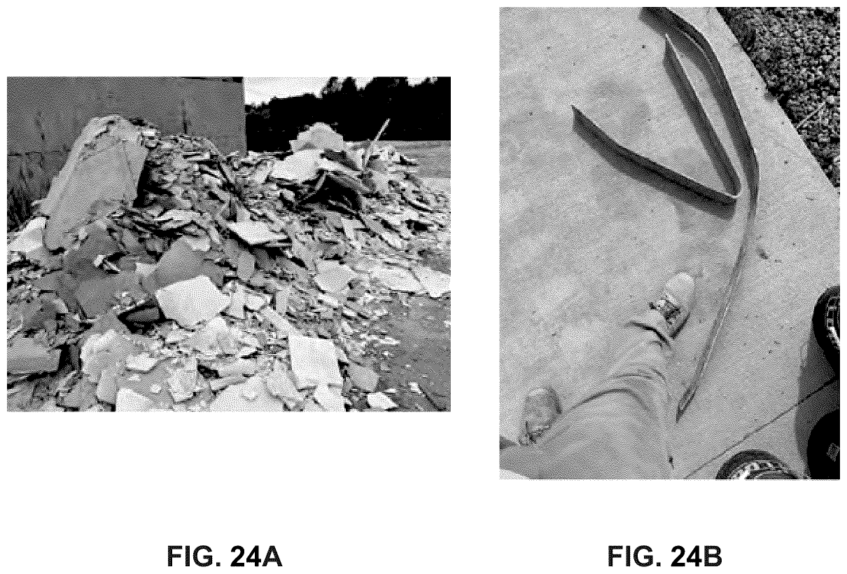

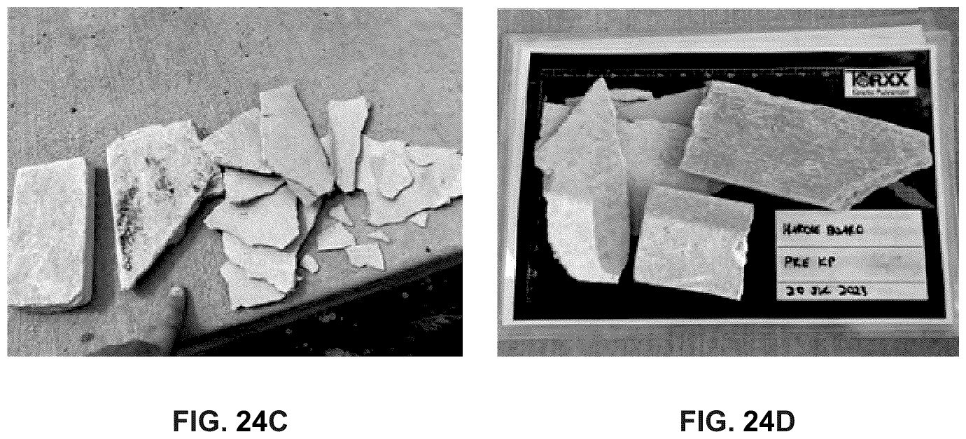

Referring now to FIGS. 24A to 28E, Hardie™ siding boards were obtained at the end of their use life to form the fiber-reinforced feedstock. The Hardie™ siding boards were composed of fiber-reinforced concrete. The Hardie™ siding boards underwent a manual sorting stage where large pieces of infrangible material were manually sorted out of the fiber-reinforced feedstock (FIG. 24B) to produce a sorted stream (FIG. 24A). The sorted stream was subjected to a size-reduction pre-treatment stage to produce an undersized stream (FIGS. 24C and 24D) having a size of about under 10 inches.

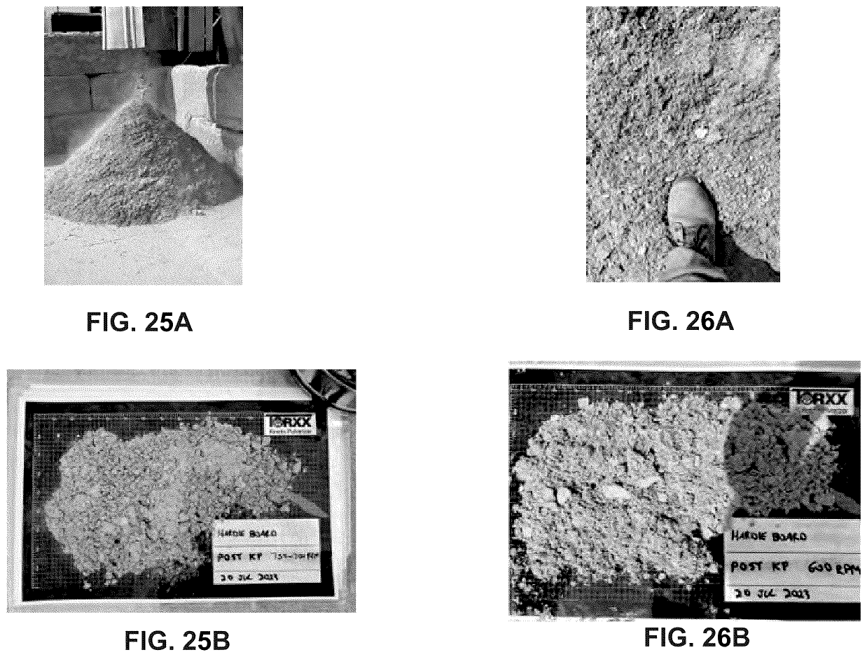

Six (6) pounds of the undersized stream was subjected to a kinetic pulverization stage with the kinetic pulverizer operated at 800 RPM reduced to 750 RPM and further reduced to 700 RPM to produce a first pulverized material (FIGS. 25A and 25B). Four (4) pounds of the undersized stream was subjected to a kinetic pulverization stage with the kinetic pulverizer operated at 600 RPM to produce a second pulverized material (FIGS. 26A and 26B). The length of the run time at 800 RPM to 700 RPM was 12 minutes and 10 seconds and the run time at 600 RPM was 5 minutes and 8 seconds.

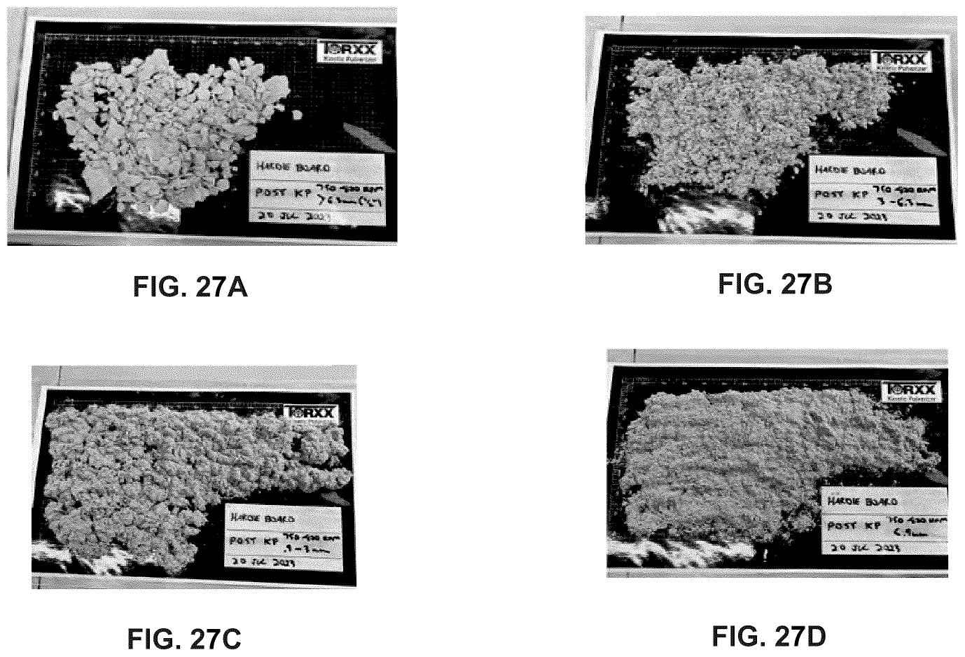

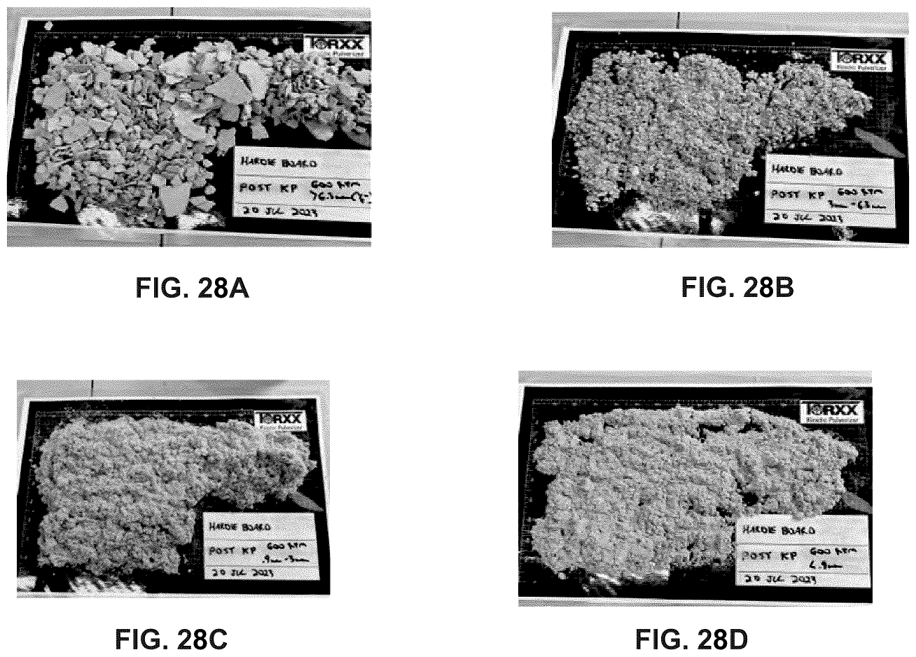

Referring now to FIGS. 27A to 27D, the first pulverized material was subjected to multiple sequential separation stages using 6.3 mm, 3 mm, and 0.9 mm mechanical screens, respectfully. Referring now to FIGS. 28A to 28D, the second pulverized material was subjected to multiple sequential separation stages using 6.3 mm, 3 mm, and 0.9 mm mechanical screens, respectfully. The resulting size reduction fractions of the pulverized output are shown in Table 1.

TABLE 1

| | 800 to 750 RPM Sample | | 600 RPM Sample | |
|---|---|---|---|---|
| | (6 pounds) | | (4 pounds) | |
| Size | weight | percentage | weight | percentage |
| >6.3 mm | 0.406 | 6.77% | 1.016 | 25.4% |
| (¼ inch) | | | | |
| 3 mm to 6.3 | 0.746 | 12.43% | 1.428 | 35.7% |
| mm | | | | |
| 0.9 mm to 3 | 1.844 | 30.73% | 0.640 | 16% |
| mm | | | | |
| <0.9 mm | 2.194 | 36.57% | 0.896 | 22.4% |
| Loss/Dust | — | 13.5% | — | 0.5% |
| Fraction | | | | |

While the above description provides examples of the embodiments, it will be appreciated that some features and/or functions of the described embodiments are susceptible to modification without departing from the spirit and principles of operation of the described embodiments. Accordingly, what has been described above has been intended to be illustrative and non-limiting and it will be understood by persons skilled in the art that other variants and modifications may be made without departing from the scope of the invention as defined in the claims appended hereto.

1. A process for treating wind turbine blades comprising:
providing the wind turbine blades which comprise a fiber component embedded in a binder component;
subjecting the wind turbine blades to a kinetic pulverization stage to produce a pulverized material, wherein the wind turbine blades are fed into a kinetic pulverizer and subjected to self-collisions created by vortices within the kinetic pulverizer to airstrip the binder component from the fiber component and produce a size-reduced fraction derived from the binder component and an oversized fraction derived from the fiber component;
withdrawing the pulverized material from the kinetic pulverizer; and
subjecting the pulverized material to one or more separation stages to produce a binder stream comprising the binder component and a fiber stream comprising the fiber component.

2. The process as claimed in claim 1, further comprising:
subjecting the wind turbine blades to a size-reduction pre-treatment stage to produce a size-reduced feedstock.

3. The process as claimed in claim 2, further comprising:
subjecting the size-reduced feedstock to one or more size-based pre-treatment separation stages to produce an oversized stream and an undersized stream.

4. The process as claimed in claim 3, wherein the oversized stream is redirected back to the size reduction pre-treatment stage.

5. The process as claimed in claim 3, wherein the undersized stream is subjected to the kinetic pulverization stage.

6. The process as claimed in claim 1, further comprising:
subjecting the pulverized material to one or more subsequent kinetic pulverization stages.

7. The process as claimed in claim 1, wherein a number of the subsequent kinectic pulverization stages is selected according to a strength of the binder component.

8. The process as claimed in claim 1, wherein the kinetic pulverizer is operated to optimize a resident time of the wind turbine blades in the kinetic pulverizer.

9. The process as claimed in claim 8, wherein the resident time of the wind turbine blades in the kinetic pulverizer is selected according to a strength of the binder component.

10. The process as claimed in claim 1, wherein each separation stage comprises screening.

11. The process as claimed in claim 10, wherein the screening comprises using a single screen or two or more screens arranged in parallel or in series.

12. The process as claimed in claim 10, wherein the screening is performed using a mechanical screen.

13. The process as claimed in claim 10, wherein the screening is performed using at least one of: a trommel screen, a vibrating screen, a tumbler screen, a gyratory screen, and a high frequency screen.

14. The process as claimed in claim 1, wherein the one or more separation stages include a plurality of separation stages, and further wherein each separation stage produces an oversized stream and an undersized stream, each undersized stream being subjected to a subsequent one of the separation stages.

15. The process as claimed in claim 14, wherein the separation stages include successively finer mechanical screens.

16. The process as claimed in claim 1, further comprising: subjecting the pulverized material to one or more dust collection stage to recover a dust fraction therefrom and produce a dust reduced pulverized stream and a dust stream.

17. The process as claimed in claim 1, wherein the kinetic pulverizer is operated at a rotation speed of between 500 RPM and 1200 RPM.

18. A wind turbine blade processing system comprising:
a kinetic pulverizer configured to receive and process a wind turbine blade feedstock to produce a pulverized stream;
a pulverizer conveyor configured to transport the pulverized stream downstream; and
at least one separator operatively coupled to the pulverizer conveyor and configured to receive the pulverized stream and produce a binder stream comprising the binder component and a fiber stream comprising the fiber component.

19. The system as claimed in claim 18, further comprising: a monitoring unit configured for monitoring at least one feed parameter of the wind turbine blade feedstock and/or at least one output parameter of the pulverized stream, the oversized stream, and/or the size-reduced stream; and a control unit coupled to the monitoring unit and configured for adjusting the kinetic pulverizer based on the at least one feed parameter and/or the at least one output parameter.

20. The system as claimed in claim 19, wherein the monitoring unit and the control unit are configured such that the at least one feed parameter comprises a feed rate of the wind turbine blade feedstock and/or a composition of the wind turbine blade feedstock.
